(19) United States
(12) Patent Application Publication
(10) Pub. No.: US 2026/0350113 A1
(43) Pub. Date: Nov. 5, 2026

(54) SYSTEMS AND METHODS FOR SIMULATING AT LEAST ONE SOLUTION OF A STOCHASTIC DIFFERENTIAL EQUATION AND METHODS FOR USING THEREOF FOR GENERATIVE MACHINE LEARNING

(71) Applicant: Irreversible Inc., Sherbrooke (CA)

(72) Inventors: Kyle MILLS, Vancouver (CA); Farhad KHOSRAVI, Vancouver (CA); Sophie ROCHETTE, Vancouver (CA); Pooya RONAGH, Vancouver (CA)

(21) Appl. No.: 19/118,744

(22) PCT Filed: Oct. 6, 2023
(86) PCT No.: PCT/IB2023/060066

§ 371 Date: Apr. 4, 2025

(51) Int. Cl. G06F 17/13; G06E 3/00

(52) U.S. Cl. CPC G06F 17/13; G06E 3/005

(57) ABSTRACT

An opto-electronic system and method for simulating at least one solution of a stochastic differential equation (SDE) driven by a Levy process wherein the stochasticity of the Levy process is represented by photon statistics of at least one optical mode. The system comprises at least one input port for receiving the at least one optical mode, a computation and recurrence component, and an output port for readout.

### CROSS-REFERENCE

This application claims the benefit of U.S. Provisional Application No. 63/378,677, filed Oct. 6, 2022; U.S. Provisional Application No. 63/380,338, filed Oct. 20, 2022; U.S. Provisional Application No. 63/479,512, filed Jan. 11, 2023; U.S. Provisional Application No. 63/501,317, filed May 10, 2023; U.S. Provisional Application No. 63/509,563, filed Jun. 22, 2023; and U.S. Provisional Application No. 63/514,047, filed Jul. 17, 2023, each of which applications is incorporated herein by reference in its entirety.

### BACKGROUND

Stochastic differential equations (SDE) may be used to describe the dynamics of a random process, which in turn models a vast variety of phenomena. Due to the stochasticity in these equations, a range of quantum and classical algorithms may benefit from them. Stochastic differential equations may be used for many applications, ranging from solving optimization problems to implementing machine learning (ML) models. For example, by performing a random walk using a drift term that guides a stochastic process towards a minimum of an objective function, they can drive the process towards the global minimum of a complex non-convex objective function.

Generative machine learning is a field of research that aims to use the exceptional pattern recognition and representation generalization abilities of machine learning to learn to generate structure from randomness. At least one goal of generative learning may be framed as a data point augmentation, transformation, or generation task. For example, given a dataset of training examples that come from an underlying data distribution, the generative model may provide a mechanism for producing samples not present in the dataset, but appear indistinguishable, or nearly indistinguishable, from examples from the dataset. A sample that is indistinguishable may comprise generated data appears “real” to a human. The generative model may capture the relevant underlying features of the data's distribution and provide a mechanism for extracting data from (e.g., sampling from) this distribution.

Generative machine learning has many applications. For example, generative models may be used to augment datasets for training other machine learning models (e.g., data augmentation), for anomaly detection (e.g., in fraud detection or disease screening), and in image-to-image transfer learning (e.g., in transferring artistic styles between paintings, colouring black-and-white photos, reconstructing obfuscated images, etc.). Generative models can be used to create photorealistic images from text-based prompts (e.g., in stock photo generation).

### SUMMARY

The present disclosure provides opto-electronic systems and methods for simulating at least one solution of a stochastic differential equation (SDE) driven by a Levy process wherein the stochasticity of the Levy process is represented by photon statistics of at least one optical mode and methods for using such systems and methods for generative machine learning. The present disclosure may improve upon existing systems and methods for simulating at least one solution of a stochastic differential equation in at least some aspects by using an optical quantum device advantageously.

Systems and methods of the present disclosure provide at least some of the following advantages. By operating at optical frequencies, the systems disclosed herein may be capable of operating at clock speed that are orders of magnitude faster than their electronic counterparts. Furthermore, by taking advantage of the quantum noise introduced due to quantum measurements or injected optical states, such systems may efficiently produce a natural random process required for all stochastic dynamics. Optical quantum devices may consume less energy than electronic alternatives, reducing operating expenses for the evaluation of diffusion models. Systems and methods disclosed herein can also directly implement continuous variables of a given optimization problem or a machine learning model by directly mapping these variables to the continuous properties of an optical quantum device (e.g., pulse amplitude) and therefore remove or reduce the need for binarization (e.g., there may be no need to convert the continuous variables of a problem to binary ones). This can substantially reduce the required number of resources. An optical quantum device can also operate at room temperature, which removes or reduce the need for expensive and energy-consuming cryogenics. Systems and methods disclosed herein may take advantage of the internal functioning of an optical device by using its noise and physical evolution to simulate the dynamics of a stochastic differential equation. The systems and methods disclosed herein may rely on analog electronic circuits to implement the drift term, including resistive memory arrays. This approach may provide low power consumption and fast processing times compared to digital approaches.

In an aspect, the present disclosure provides, an opto-electronic system for simulating at least one solution of a stochastic differential equation (SDE) driven by a Levy process. The system may comprise at least one input port for receiving at least one optical mode, wherein a stochasticity of the Levy process is represented by photon statistics of the at least one optical mode; and a computation and recurrence component configured to perform one or more operations on one or more signals derivative of the at least one optical mode to simulate the at least one solution to the stochastic differential equation.

In some embodiments, the computation and recurrence component is further configured to implement at least a portion of a generative machine learning model based on the at least one optical mode. In some embodiments, the system further comprises an output port configured to provide a readout, wherein the at least one solution of the stochastic differential equation is based at least in part on the readout. In some embodiments, the computation and recurrence component comprises one or more members selected from the group consisting of: a digital electronic component, an analog electronic component, an opto-electronic component, and an optical component. In some embodiments, the computation and recurrence component comprise a network of optical components. In some embodiments, the analog electronic component comprises a resistive random-access memory (RRAM) device. In some embodiments, the digital electronic component comprises a field-programmable gate array (FPGA).

In some embodiments, the system further comprises one or more optical waveguides, wherein the one or more optical waveguides comprise the at least one optical mode. In some embodiments, the computation and recurrence component comprises one or more optical components, wherein at least one of the one or more optical components comprises at least one coupler, wherein the at least one coupler is configured to receive an optical mode via an input port of the at least one of the one or more optical components. In some embodiments, the computation and recurrence component comprises a measurement module configured to perform a homodyne measurement of the at least one optical mode. In some embodiments, each variable and one or more parameters of the SDE is represented by at least one of an optical signal or an electronic signal. In some embodiments, the signals encode information using a current pattern. In some embodiments, the signals encode information using a voltage pattern.

In some embodiments, the computation and recurrence component comprises a feedback loop comprising at least one of an electronic component or an optical component. In some embodiments, the computation and recurrence component comprises a signal aggregator configured to add signals. In some embodiments, signal aggregator comprises a circuit node, a summing amplifier circuit, or one or more optical components comprising at least one coupler. In some embodiments, the at least one optical mode comprises at least one member of the group consisting of: a squeezed state, a vacuum state, and a coherent state; further wherein the at least one optical mode is injected using the at least one input port. In some embodiments, the optical mode comprises a vacuum state converted into a squeezed state using the computation and recurrence component.

In some embodiments, the stochasticity is controlled using quantum measurements. In some embodiments, a quantum measurement from the quantum measurements changes the photon statistics of one or more optical modes of the at least one optical mode. In some embodiments, a quantum measurement of an optical mode of the at least one optical mode creates an optical mode with photon statistics different from that of the measured optical mode. In some embodiments, operating in low-photon regime, the quantum measurements comprise weak quantum measurements and are performed by the environment. In some embodiments, the at least one coupler is at least one of a tunable coupler or a fixed coupler. In some embodiments, the one or more optical components comprise at least one member of the group consisting of: a beam splitter, a phase shifter, an amplifier, and a squeezer. In some embodiments, the one or more optical components comprise at least one nonlinear optical component. In some embodiments, the one or more optical components comprise a Mach-Zehnder interferometer (MZI) comprising two 50:50 beam splitters and at least one phase shifter. In some embodiments, the computation and recurrence component comprises an MZI mesh comprising a network of MZIs, wherein the MZI mesh is configured to implement an analog optical matrix-vector multiplication (MVM) unit. In some embodiments, the computation and recurrence component comprises a free-space analog optical matrix-vector multiplication (MVM) unit.

In some embodiments, the computation and recurrence component comprises a processing network, wherein an output of the processing network is at least in part representative of a drift term of the stochastic differential equation. In some embodiments, the computation and recurrence component comprises a processing network, wherein an output of the processing network is at least in part representative of the stochasticity, which stochasticity is generated using results of the homodyne measurement of the at least one optical mode. In some embodiments, the measurement module is operatively optically connected using one or more optical waveguides to the at least one coupler, wherein the one or more optical waveguides are arranged in a closed loop, wherein the output of the homodyne measurement is fed back into the at least one coupler. In some embodiments, wherein the system further comprises one or more optical cavities comprising the one or more optical waveguides arranged in a closed loop connecting the at least one coupler and the measurement module, wherein the output of the homodyne measurement is fed back into the one or more optical cavities. In some embodiments, the one or more optical waveguides is optical fibre.

In some embodiments, the computation and recurrence component is configured to encode representations of latent variables, wherein the latent variables comprise portions of a machine learning (ML) model. In some embodiments, the computation and recurrence component is configured to simulate at least one solution to a forward stochastic differential equation, wherein the at least one solution to the stochastic differential equation is used to train a generative machine learning (ML) model. In some embodiments, the computation and recurrence component comprises a function approximator comprising one or more parameters and one or more variables as an input. In some embodiments, the function approximator is trained to approximate a score function of a machine learning (ML) model. In some embodiments, the drift term of the stochastic differential equation comprises a drift term of a reverse stochastic differential equation representative of a reverse diffusion. In some embodiments, the function approximator is trained for approximating a function representative of a log of a probability distribution of data of a machine learning (ML) model. In some embodiments, the function approximator is trained for approximating the gradient of a function representative of a log of a probability distribution of data of a machine learning (ML) model.

In some embodiments, the stochastic differential equation is representative of Langevin dynamics. In some embodiments, the function approximator comprises a neural network. In some embodiments, the neural network comprises an optical neural network or an analog electronic neural network. In some embodiments, the stochastic differential equation is representative of an optimization problem. In some embodiments, the optimization problem is at least one member of the group consisting of: a box-constrained quadratic programming problem, a maximum-weighted independent set optimization problem, and a quadratic assignment optimization problem.

In another aspect, the present disclosure provides a method for simulating at least one solution of a stochastic differential equation (SDE) driven by a Levy process in an opto-electronic system. The method may comprise: (a) generating, at an opto-electronic system signals representative of an initial condition of the variables and one or more parameters of the stochastic differential equation (SDE); (b) receiving, at the at least one input port, one or more optical modes having photon statistics representative at least in part of the stochasticity of the Levy process which Levy process drives the stochastic differential equation (SDE); and (c) performing, at a computation and recurrence component operatively coupled to the input port, one or more operations the signals representative of the variables and the one or more parameters of the stochastic differential equation (SDE) and one or more signals derivative of the at least one optical mode to simulate the at least one solution to the stochastic differential equation.

In some embodiments, the method further comprises performing, at the computation and recurrence component, recurrence by repeating (b) and (c) at least one time. In some embodiments, the method further comprises providing a readout at a readout port of the opto-electronic system. In some embodiments, the stochastic differential equation (SDE) is representative of an optimization problem. In some embodiments, a drift term of the stochastic differential equation (SDE) is representative of at least one member of the group consisting of: the gradient of an objective function, a function of the gradient of an objective function, and a time-dependent function of the gradient of an objective function that depends on previous times. In some embodiments, the optimization problem is at least one member of the group consisting of: a box-constrained quadratic programming problem, a maximum-weighted independent set optimization problem, and a quadratic assignment optimization problem.

In some embodiments, the stochastic differential equation (SDE) is representative of Langevin dynamics. In some embodiments, the one or more operations comprise at least one member of the group consisting of: (i) an analog optical operation; (ii) a digital operation; (iii) an analog electronic operation; (iv) converting a digital signal to an optical mode; (v) converting an analog electronic signal to an optical mode; (vi) converting an analog electronic signal to a digital signal; (vii) converting a digital signal to an analog electronic signal; (viii) converting an optical mode to a digital signal; and (ix) converting an optical mode to an analog electronic signal. In some embodiments, the converting of an optical mode to a digital signal comprises converting the optical mode to an analog electronic signal and converting the analog electronic signal to the digital signal; further wherein the converting a digital signal to an optical mode comprises converting the digital signal to an analog electronic signal and converting the analog electronic signal to the optical mode.

In another aspect, the present disclosure provides a method for generating an approximated sample from the distribution of the training data. The method may comprise: (a) obtaining values of a plurality of parameters of a trained function approximator, wherein the trained function approximator is representative at least in part of a machine learning (ML) model; (b) implementing the trained function approximator on an opto-electronic system using at least the values of the plurality of parameters, wherein the opto-electronic system comprises at least one input port configured to receive at least one optical mode, and a computation and recurrence component; (c) simulating, at the opto-electronic system, at least one solution of a stochastic differential equation (SDE) driven by a Levy process representative of the distribution of the training data of the machine learning (ML) model; and (d) generating an approximated sample based at least in part on the at least one solution from the distribution of the training data.

In some embodiments, the method further comprises prior to (a) training the function approximator to obtain the parameters' values. In some embodiments, the training comprises: (A) obtaining a number of iterations t between zero and a maximum number of iterations; and (B) initializing the opto-electronic system using a sample of the training data of the machine learning (ML) model; (C) running the opto-electronic system for t iterations to simulate until t the at least one solution of the stochastic differential equation (SDE) driven by the Levy process representative of the machine learning (ML) model; and (D) outputting the state of the opto-electronic system after t iterations. In some embodiments, the method further comprises updating the parameters' values of the function approximator. In some embodiments, (A)-(D) the updating of the parameters' values of the function approximator are repeated at least one time.

In another aspect, the present disclosure provides an optical system for simulating at least one solution of a stochastic differential equation. The optical system may comprise: one or more optical components generating a controllable noise representative of the randomness of the stochastic differential equation, which controllable noise is generated using weak quantum measurements.

In some embodiments, the one or more optical components further generating a drift term of the stochastic differential equation. In some embodiments, the weak quantum measurement(s) is a measurement(s) of a quantum mode. In some embodiments, the system further comprises a feedback loop, wherein the output of the weak quantum measurement is used to generate the feedback signal. In some embodiments, the system is operating in low photon regime. In some embodiments, the system is operating in low photon regime and the weak quantum measurement is presented by the environment. In some embodiments, the feedback loop comprises one or more optical cavities.

In some embodiments, the drift term is programmable. In some embodiments, the drift term is generated using a digital computing device. In some embodiments, the drift term is generated using field programmable gate array (FPGA). In some embodiments, the drift term is generated using the optical components. In some embodiments, the one or more optical components comprise at least one member of the group consisting of a beam splitter, a phase shifter, an amplifier, and a squeezer. In some embodiments, the one or more optical components comprise at least one non-linear optical component.

In some embodiments the system is used for performing forward stochastic differential equation for training a generative machine learning (ML) model. In some embodiments, the drift term comprises a function approximator comprising one or more parameters and receiving one or more variables as inputs. In some embodiments, the drift term of the stochastic differential equation comprises score function of a machine learning diffusion model. In some embodiments, the function approximator is trained for approximating the score function of a machine learning diffusion model. In some embodiments, the drift term of the stochastic differential equation comprises the drift term of an inverse diffusion. In some embodiments, the function approximator is trained for approximating a function representative of the log of the probability distribution of data of a machine learning model. In some embodiments, the function approximator is trained for approximating gradient of a function representative of the log of the probability distribution of data of a machine learning model.

In some embodiments, the stochastic differential equation is representative of Langevin dynamics. In some embodiments, the function approximator comprises a neural network. In some embodiments, the neural network comprises an optical neural network. In some embodiments, the system further comprises a plurality of function approximators having identical parameters, the function approximators are coupled using one or more optical cavities.

In another aspect, the present disclosure provides a method for simulating at least one solution of a stochastic differential equation. The method may comprise: (a) at an optical system comprising a network of optical components having one or more optical components, generating a plurality of optical pulses representative of a random variable serving as an initial condition of dynamics described by a stochastic differential equation; (b) performing one or more quantum measurements on the plurality of optical pulses; and (c) performing one or more optical operations on the plurality of optical pulses using the network of optical components.

In some embodiments, the optical pulses comprise vacuum states or coherent states. In some embodiments, the method further comprises performing digital operations on the plurality of optical pulses comprising converting one or more optical pulses of the plurality of optical pulses to digital signals, performing digital processing on the one or more optical pulses, and converting the one or more optical pulses back to optical pulses. In some embodiments, the method further comprises repeating (b) and (c) one or more times.

In another aspect, the present disclosure provides a method for generating an approximated sample from the distribution of the training data. The method may comprise: (a) obtaining a trained function approximator parameters' values, the trained function approximator approximating the score function of a machine learning diffusion model; (b) using the obtained parameters' values to implement the trained function approximator on an optical system, the optical system comprising one or more optical components; (c) running the optical system to perform dynamics described by a stochastic differential equation representative of the distribution of the training data of the machine learning diffusion model; and (d) reporting results to generate an approximated sample from the distribution of the training data.

In some embodiments, the method further comprises, prior to (a), training the function approximator to obtain parameters' values. In some embodiments, training comprises: (A) sampling time t between zero and maximum time; (B) initializing the optical system using a sample of the training data of the machine learning diffusion model; (C) running the optical system for t iterations to perform dynamics described by a stochastic differential equation representative of a diffusion process of the machine learning diffusion model; and (D) outputting the state of the system after t iterations. In some embodiments, the method further comprises updating parameters values of the function approximator.

In another aspect, the present disclosure provides an optical system for simulating at least one solution described by a stochastic differential equation. The optical system may comprise: (a) at least one coupler comprising one or more optical components, the at least one coupler receiving an optical quantum mode via an input port of at least one of the one or more optical components; and (b) a measurement module for performing a homodyne measurement of the optical quantum modes, the measurement module is operatively optically connected using one or more optical waveguides to the at least one coupler; wherein a controllable noise of the optical quantum modes is generated using at least quantum measurements of the optical quantum modes, the controllable noise is representative of at least a portion of the randomness of a stochastic differential equation.

In some embodiments, the system further comprises a processing network operatively connected to the at least one coupler, the processing network generating at least one programmable optical mode at least in part representative of a drift of the stochastic differential equation. In some embodiments, the processing network is operatively connected to the measurement module, further wherein the at least one generated programmable optical mode is at least in part representative of at least a portion of the randomness of the stochastic differential equation and is generated using results of the homodyne measurement of the optical quantum modes, further wherein the generated at least one programmable optical mode is fed back to the system. In some embodiments, the processing network comprises at least one member of the group consisting of a digital electronics component, an analog electronics component, an optoelectronic component, and an optical component. In some embodiments, the analog electronics component is a resistive random-access memory (RRAM) device. In some embodiments, the digital electronics component is a field programmable gate array (FPGA). In some embodiments, the at least one coupler is at least one of a tunable coupler and a fixed coupler. In some embodiments, the optical quantum mode is in squeezed state, further wherein the amount of squeezing of the squeezed state controls the controllable noise of the optical quantum mode. In some embodiments, the squeezed state is injected using the at least one coupler. In some embodiments, the optical quantum mode is in squeezed state, and wherein the amount of squeezing of the squeezed state controls the controllable noise of the optical quantum mode, further wherein the squeezed state is generated using the processing network. In some embodiments, the one or more optical waveguides are arranged in closed loop connecting the at least one coupler and the measurement module, wherein the output of the homodyne quantum measurement is fed back into the at least one coupler.

In some embodiments, the system further comprises one or more optical cavities comprising the one or more optical waveguides arranged in closed loop connecting the at least one coupler and the measurement module, wherein the output of the homodyne quantum measurement is fed back into the one or more optical cavities. In some embodiments, the one or more optical waveguides are optical fiber. In some embodiments, the system is operating in low photon regime. In some embodiments, the system is operating wherein the quantum measurement is a weak quantum measurement and is performed by the environment. In some embodiments, the one or more optical components comprise at least one member of the group consisting of a beam splitter, a phase shifter, an amplifier, and a squeezer. In some embodiments, the one or more optical components comprise at least one non-linear optical component.

In some embodiments, the system is used for encoding latent variable representations, the latent variables used in a machine learning method. In some embodiments, the system is used for performing a forward stochastic differential equation for training a generative machine learning (ML) model. In some embodiments, the processing network comprises a function approximator comprising one or more parameters and receiving one or more variables as inputs. In some embodiments, the function approximator is trained for approximating the score function of a machine learning model. In some embodiments, the drift term of the stochastic differential equation comprises the drift term of an inverse diffusion. In some embodiments, the function approximator is trained for approximating a function representative of the log of the probability distribution of data of a machine learning model. In some embodiments, the function approximator is trained for approximating gradient of a function representative of the log of the probability distribution of data of a machine learning model. In some embodiments, the stochastic differential equation is representative of Langevin dynamics. In some embodiments, the function approximator comprises a neural network. In some embodiments, the neural network comprises an optical neural network.

In another aspect, the present disclosure provides a method for performing dynamics described by a stochastic differential equation. The method may comprise: (a) at an optical system comprising at least one coupler comprising one or more optical components, injecting a plurality of optical quantum modes representative of a random variable serving as an initial condition of dynamics described by a stochastic differential equation; (b) performing one or more quantum measurements on the plurality of optical quantum modes; (c) performing one or more operations on the plurality of optical quantum modes using the one or more optical components.

In some embodiments, aid one or more operations comprise at least one member of the group consisting of: (i) an analog optical operation; (ii) a digital operation comprising converting one or more optical quantum modes of the plurality of optical quantum modes to digital signals, performing digital processing on the digital signals, and converting the digital signals back to optical quantum modes; and (iii) an analog electronic operation comprising converting one or more optical quantum modes of the plurality of optical quantum modes to analog electronic signals, performing analog electronic processing on the analog electronic signals, and converting the analog electronic signals back to optical quantum modes. In some embodiments, the converting one or more optical quantum modes of the plurality of optical quantum modes to digital signals comprises converting the one or more optical quantum modes of the plurality of optical quantum modes to analog electronic signals and converting the analog electronic signals to the digital signals; further wherein the converting the digital signals back to optical quantum modes comprises converting the digital signals to analog electronic signals and converting the analog electronic signals to optical quantum modes. In some embodiments, the method further comprises repeating (b) and (c) one or more times.

In another aspect, the present disclosure provides a method for generating an approximated sample from the distribution of the training data. The method may comprise: (a) obtaining a trained function approximator parameters' values, the trained function approximator representative at least in part of a machine learning model; (b) using the obtained parameters' values to implement the trained function approximator on an optical system, the optical system comprising one or more optical components; (c) running the optical system to perform dynamics described by a stochastic differential equation representative of the distribution of the training data of the machine learning model; and (d) reporting results to generate an approximated sample from the distribution of the training data.

In some embodiments, the method further comprises, prior to (a), training the function approximator to obtain parameters' values. In some embodiments, training comprises: (A) obtaining t between zero and maximum number of iterations; (B) initializing the optical system using a sample of the training data of the machine learning model; (C) running the optical system for t iterations to perform dynamics until t, the dynamics described by a stochastic differential equation representative of the machine learning model; and (D) outputting the state of the system after t iterations. In some embodiments, the method further comprises updating parameters values of the function approximator.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a diagram of an opto-electronic system for simulating at least one solution of a stochastic differential equation (SDE) driven by a Levy process wherein the stochasticity of the Levy process is represented by photon statistics of at least one optical mode.

FIG. 2 is a flowchart of a method for simulating at least one solution of a stochastic differential equation (SDE) driven by a Levy process wherein the stochasticity of the Levy process is represented by photon statistics of at least one optical mode.

FIG. 3A is a diagram of an opto-electronic system for simulating at least one solution of a stochastic differential equation (SDE) driven by a Levy process wherein the stochasticity of the Levy process is represented by photon statistics of at least one optical mode, the opto-electronic system having optical components.

FIG. 3B is a diagram of an opto-electronic system for simulating at least one solution of a stochastic differential equation (SDE) driven by a Levy process wherein the stochasticity of the Levy process is represented by photon statistics of at least one optical mode, the opto-electronic system having a processing network.

FIG. 3C is a diagram of an opto-electronic system for simulating at least one solution of a stochastic differential equation (SDE) driven by a Levy process wherein the stochasticity of the Levy process is represented by photon statistics of at least one optical mode, the opto-electronic system having two processing networks.

FIG. 4 is a flowchart of a method for generating an approximated sample from the distribution of training data.

FIG. 5 is a flowchart of a method for training a function approximator.

FIG. 6 is a flowchart of a method for generating a sample from the distribution of the training data of a generative machine learning model using a hybrid opto-electronic system having an optical device coupled with an electronic score function approximator.

FIG. 7 is a flowchart of a method for generating a sample from the distribution of the training data of a generative machine learning model using an opto-electronic system having an optical score function approximator.

FIG. 8 is a flowchart of a method for simulating the dynamics described by a stochastic differential equation (SDE).

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

Neither the Title nor the Abstract is to be taken as limiting in any way the scope of the disclosed invention(s). The title of the present application and headings of sections provided in the present application are for convenience only and are not to be taken as limiting the disclosure in any way.

### High-Performance Computing Device

A computing device disclosed herein which may interact with a photonic computing device disclosed herein, for example, a coherent optical network, may be a high-performance computing (HPC) device. An HPC device may comprise one or more of a graphics processing unit (GPU), a tensor processing unit (TPU), a field-programmable gate array (FPGA), an application-specific integrated circuit (ASIC), and a tensor streaming processor (TSP). Any other suitable processing unit that is capable of performing matrix multiplication may be used. Certain computing devices may be more efficient at operations such as matrix multiplication. These computing devices may provide additional efficiency gains over other computing systems. For example, a matrix multiplication device may be a GPU. A GPU may be a specialized electronic circuit, optimized for high throughput, that can perform the same set of operations in parallel on many data blocks at a time. For example, a matrix multiplication device may be a TPU. A TPU may be a type of ASIC developed for low-bit precision processing, for example, such as that developed by Google Inc.; see patent application US 2016/0342891A1, which is incorporated by reference herein for all purposes. Another example of a matrix multiplication device may be an FPGA. An FPGA may be an integrated circuit chip that comprises configurable logic blocks and programmable interconnects. It can be programmed after manufacturing to execute custom algorithms. Another example of a matrix multiplication device may be an ASIC. An ASIC may be an integrated circuit chip that is customized to run a specific algorithm. In some case, an ASIC cannot be programmed after manufacturing. Another example of a matrix multiplication device may be a TSP. A TSP may be a domain-specific programmable integrated chip that is designed for linear algebra computations as they may be performed in artificial intelligence applications, an example of which may be found Gwennap, Linley, “Groq rocks neural networks,” The Linley Group, Microprocessor Report, Tech. Rep., January 2020, which is incorporated by reference herein for all purposes.

### Optical Computing Device/Quantum Optical Device

The computational task discussed herein may be performed by a quantum optical device. A quantum optical device may be a non-classical computer which is an optical computing device. A quantum optical device may be an apparatus comprising optical elements which may act as quantum gates on photons. In some cases, optical elements maintain the quantum coherence between different quantum states. In some cases, the inputs and outputs of a quantum optical device are qumodes. By contrast, a classical computer, classical computing, or classical computation may be a computation performed using binary values using discrete bits or analog values without use of quantum mechanical superposition and quantum mechanical entanglement. A classical computer may be a digital computer, such as a computer employing discrete bits (e.g., 0's and 1's) without use of quantum mechanical superposition and quantum mechanical entanglement, or an analog computer employing continuous variables without use of quantum mechanical superposition and quantum mechanical entanglement.

A non-classical computer, non-classical computing, or non-classical computation may be any method or system for performing computational procedures outside of the paradigm of classical computing. In some cases, a non-classical computer is a quantum computer. A quantum device may be a device or system for performing computations using any quantum mechanical phenomenon such as quantum mechanical superposition and quantum mechanical entanglement. A quantum computation, quantum procedure, quantum operation, or a quantum computer may be a method or system for performing computations using quantum mechanical operations (such as unitary transformations or completely positive trace-preserving (CPTP) maps on quantum channels) on a Hilbert space represented by a quantum device.

A qubit may be a unit of quantum information processing whose quantum state is a complex unit vector of dimension 2. These two dimensions are typically referred to as “0” and “1”. When quantum error correction is used, a logical qubit may be one of the set of physical qubits that encodes one fault-tolerant qubit. A qumode may be a quantum state represented as a quantum optical mode. A quantum optical mode may be an optical mode expressed as a superposition of a set of possible quantum photon-number states. The optical mode may be a single quantum optical mode of a quantum optical device as described herein. The superposition may be an infinite superposition of all possible quantum photon-number states. A qumode may be an alternative to representing quantum information in terms of qubits or qudits. A qubit may be a discrete packet of information representing a superposition of binary values, e.g., zero and one. A quantum gate may be to one of a sequence of operations in a gate model quantum computer. A quantum gate may be a physical device that transforms a quantum state of its input according to a unitary transformation that describes the particular action of the quantum gate.

A quantum optical device may prepare initial optical quantum states (e.g., qumodes) and perform a series of quantum gates on these optical quantum states. These gates may use quantum optical elements that may perform appropriate quantum unitary transformations. The quantum optical device may further perform quantum measurements, such as homodyne measurements, to introduce quantum noise or to determine the mean-field amplitudes of the optical pulses. This determination may be performed by measuring the amplitude and the phase of the optical pulses and comparing them against some reference amplitude and phase, using a method similar to what is disclosed in the patent U.S. Pat. No. 10,139,703 B2 or in “A fully programmable 100-spin coherent Ising machine with all-to-all connections” McMahon et al., Science 354, no. 6312:614-617, 2016, which is incorporated by reference herein for all purposes.

The quantum optical device may further perform quantum measurements, such as photon-number-resolving (PNR) measurements and homodyne detections, on the qumodes to determine the final quantum states. This determination may be performed by statistically finding the probability distributions of the final quantum states in the quantum number basis, which may be determined through repeated measurements. More details can be found in US 2019/0325589 and in “Applications of near-term photonic quantum computers: software and algorithms” by Bromley et al., Quantum Science and Technology 5, no. 3:034010, 2020, each of which is incorporated by reference herein for all purposes. In the company Xanadu's quantum optical device, for instance, the initial states may be squeezed vacuum states prepared by squeezing the on-chip vacuum states using an optical crystal with high second-order nonlinearity. In the Nippon Telegraph and Telephone (NTT) quantum optical device, the initial states may be quantum vacuum states or squeezed quantum vacuum states prepared by squeezing the vacuum states using an optical crystal with high second-order nonlinearity. An example of such crystals may be periodically poled lithium niobate (PPLN), which have been used in quantum optical devices. These squeezed vacuum states may then traverse the modules of the system disclosed herein implemented using optical elements or quantum optical gates which may perform predetermined operations. Phase shifters, for instance, may be implemented using materials with temperature-dependent refractive indices, which may be manipulated using voltage-controlled heating plates. In some examples, quantum optical gates may be used, such as on-chip and fibre optical directional couplers or beam splitters, which may create quantum superposition between qumodes. In some examples, the superposition may be between two or more qumodes.

Measurements performed on qumodes may comprise quantum PNR measurements and homodyne measurements. By measuring the intensity of the optical field, and comparing its phase to a reference phase, the results of the homodyne measurements can be used to infer the results of performing quantum measurements in the position or momentum basis. The homodyne measurement may also be implemented to introduce quantum noise to the system. While homodyne measurements are continuous measurements that may be performed with high precision, quantum PNR measurements may be more technologically demanding to perform due to difficulties in detecting single photons. Examples of photon-number detectors may include but are not limited to single-photon avalanche detectors (SPAD) that can detect whether the photon number is zero or nonzero, and photon-number-resolving detectors (PNRD), which can report the number of photons detected up to about a few photons. In some examples, a PNRD may output at least two, at least three, at least four, at least five, at least six, at least seven, at least eight, at least nine, or at least ten photons. The control voltage signals for the squeezers and the quantum operations, as well as the outcomes of the quantum measurements, may be controlled and collected by a classical computing device, such as a field-programmable gate array (FPGA), and may be converted between values meaningful in terms of the mathematical description of the computational task to voltages appropriate for the optical gates and detectors.

### Coherent Ising Machine

In some cases, a computing device such as a matrix multiplication device may be coupled to a photonic computing device. A photonic computing device may be a coherent Ising machine (CIM). A CIM is an optical device with a powerful optimization system due to its increased, for example, all-to-all, connectivity among optical pulses. Furthermore, operating at optical frequencies, the CIM may be faster compared to classical computers in solving optimization problems. The CIM may be adapted to solve the Ising problem; however, its optical pulses may be used to represent binary or continuous variables or both at the same time. Such a modification may be also referred to as a coherent optical network.

A coherent optical network may be of various types such as any type described herein. In some cases, the coherent optical network comprises optical computing devices. In some cases, the coherent optical network comprises any of the group of optical instruments that include beam splitters, nonlinear optical elements such as periodically poled lithium niobate (PPLN), free-space lasers that function on optical tables, fibre-ring resonator cavities comprising optical fibres and fibre optics instruments, phase-sensitive amplifiers (PSA), second-harmonic generators (SHG), intensity and phase modulators, photodetectors, analog-to-digital converters (ADC), digital-to-analog converters (DAC), and field-programmable gate arrays (FPGA). In some cases, the coherent optical network comprises integrated photonics.

For example, the coherent optical network or another optical device may comprise a beam splitter. A beam splitter may be an optical element with two inputs and two outputs, where the input signals may be coupled and added up to create one output signal, or one input signal may provide two out-coupled optical signals, or two input signals may create two output signals that are superpositions (classical or quantum) of the input optical signals. A beam splitter may be general table-top optical beam splitters or on-chip optical directional couplers that have the same functionality as beam splitters.

For example, the coherent optical network or another optical device may comprise an optical line. An optical line may be an optical waveguide such as optical fibres, a silicon nanophotonics waveguide, or free space through which optical pulses can travel. Optical lines may be terminated at one or both ends or may be used to create a loop to form an optical cavity. An optical cavity may be a closed optical path created from optical lines and mirrors where standing waves can be created. Optical cavities may be used to maintain the coherence of the optical pulses within a system.

For example, the coherent optical network or another optical device may comprise a Mach-Zehnder interferometer. A Mach-Zehnder interferometer (MZI) may be an optical element comprising two beam splitters and at least one phase shifter. By adjusting the phase difference between the optical modes in the two arms between the two beam splitters, phase shifters are able to control the amount that the inputs are added or subtracted at the output. Another phase shifter may be added to one of the arms in the input or output of the element to adjust the overall phase.

### Integrated Photonic Coherent Ising Machine

Another example of an optical computing device is an integrated photonic coherent Ising machine, disclosed, for instance, in “Coherent Ising machines with error correction feedback” by Satoshi Kako, Timothée Leleu, Yoshitaka Inui, Farad Khoyratee, Sam Reifenstein, and Yoshihisa Yamamoto, Advanced Quantum Technologies, Volume 3, Issue 11, 2000045, which is incorporated by reference herein for all purposes.

In some cases, an integrated photonic coherent Ising machine is a combination of nodes and a connection network for solving a particular Ising problem. In some cases, the combination of nodes and the connection network may form an optical computer that is adiabatic. In other words, the combination of the nodes and the connection network may non-deterministically solve an Ising problem when the values stored in the nodes reach a steady state to minimize the energy of the nodes and the connection network. Values stored in the nodes at the minimum energy level may be associated with values that are a solution to a particular Ising problem.

In some cases, a system comprises a plurality of ring resonator photonic nodes, wherein each one of the plurality of ring resonator photonic nodes stores a value; a pump coupled to each one of the plurality of ring resonator photonic nodes via a pump waveguide for providing energy to each one of the plurality of ring resonator photonic nodes; and a connection network comprising a plurality of two-by-two building blocks of elements, wherein each element of the two-by-two building blocks comprises a plurality of phase shifters for tuning the connection network with parameters associated with the encoding of an Ising problem, wherein the connection network processes the value stored in each one of the plurality of ring resonator photonic nodes, wherein the Ising problem is solved, wherein the value stored in each one of the plurality of ring resonator photonic nodes at a minimum energy is representative of the solution to the Ising problem.

### Analog Electronics

A computing device disclosed herein which may interact with a photonic device disclosed herein, for example, a coherent optical network, may be an analog electronic device capable of performing matrix-vector multiplication (MVM), for example a resistive random-access memory (RRAM) device such as a crossbar array of resistive memories. Such a computing device may provide additional efficiency gains over other computing systems. An RRAM device implemented as a crossbar array of resistive memories may be an integrated or discrete elements circuit where resistive memories have programmable conductance states to represent numerical values of the elements of a two-dimensional matrix. An RRAM device may be capable of implementing a matrix-vector multiplication between an input vector comprising electronic voltage signals and the matrix mapped to the programmable conductance states of the resistive memories arranged in a crossbar array, through Ohm's law and Kirchoff's law of electrical circuits. The resistive memories may represent binary or continuous values. Other types of analog electronic components may be used to compute a matrix-vector multiplication, such as analog multiplier circuits.

Analog electronic circuits can process signals with values along a continuous spectrum and produce a proportional representation of an external signal (sound, light, temperature, spatial displacement, electrical current, etc.) as an electronic voltage or current. Elementary electronic components of such analog circuits include, but are not limited to, transistors, diodes, resistors, capacitors, and inductors, and more complex building blocks include operational amplifier circuits, which can perform roles that include, but are not limited to, buffer, differential amplifier, integrator, and comparator. Analog electronic circuits may be used to perform different operations such as addition, subtraction, multiplication, division, integration, inversion, exponentiation, logarithmic computation, and division. Analog electronic circuits may be used to perform nonlinear operations on electronic signals. The electronic components forming such analog electronic circuits may comprise one or more of diodes, transistors, differential amplifiers such as operational amplifiers, and passive linear components such as resistors, inductors, and capacitors. A nonlinear function may also be generated by a crossbar array of memristive devices (or other RRAM devices).

A memristive device, resistive memory, or a resistive random-access memory (RRAM) device may comprise an electronic device with two terminals or electrodes, where the conductance state of this device is non-volatile and can be programmed or read by applying a programming voltage or current pulse or a reading voltage or current pulse on the electrodes, respectively. Memristive crossbar, crossbar array of memristive devices, or a crossbar array of resistive memories may comprise an arrangement of multiple memristive devices in a two-dimensional grid where memristive devices on the same row share a common electrode, for example, the “top” or “input” electrode, and memristive devices on the same column share a common but different electrode, for example, the “bottom” or “output” electrode.

### Digital Computer

In some cases, the systems, media, networks, and methods described herein comprise a classical computer (e.g., a digital computer), or use of the same. In some cases, a classical computer may comprise a digital computer. In some cases, the classical computer includes one or more hardware central processing units (CPU) that carry out the classical computer's functions. In some cases, the classical computer further comprises an operating system (OS) configured to perform executable instructions.

In some cases, the classical computer is connected to a computer network. In some cases, the classical computer is connected to the Internet such that it accesses the World Wide Web. In some cases, the classical computer is connected to one or more computer servers, which can enable distributed computing, such as a cloud computing infrastructure. In some cases, the classical computer is connected to an intranet and/or extranet or an intranet and/or extranet that is in communication with the Internet. In some cases, the classical computer is connected to a data storage device. In some cases, the network is a telecommunication and/or data network. In some cases, the network is a peer-to-peer network, which may enable devices coupled to the computer system to behave as a client or a server.

In accordance with the description herein, suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with systems and methods described herein. Select televisions, video players, and digital music players, in some cases with computer network connectivity, may be suitable for use with systems and methods described herein. Suitable tablet computers may include those with booklet, slate, and convertible configurations.

In some cases, the classical computer includes an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux®, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, Apple® macOS®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® webOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Sony® PS5® Microsoft® Xbox 360®, Microsoft® Xbox One®, Nintendo® Wii®, Nintendo® Wii U®, and Ouya®.

In some cases, the classical computer includes a storage and/or memory device. In some cases, the storage and/or memory device is one or more physical apparatuses used to store data or programs on a temporary or permanent basis. In some cases, the storage and/or memory device may have one or more additional data storage units that are external to the classical computer, for example, being located on a remote server that is in communication with the classical computer through an intranet or the Internet. In some cases, the device is volatile memory and requires power to maintain stored information. In some cases, the device is non-volatile memory and retains stored information when the classical computer is not powered. In some cases, the non-volatile memory comprises flash memory. In some cases, the non-volatile memory comprises dynamic random-access memory (DRAM). In some cases, the non-volatile memory comprises ferroelectric random-access memory (FRAM). In some cases, the non-volatile memory comprises phase-change random-access memory (PRAM). In some cases, the non-volatile memory comprises resistive random-access memory (RRAM). In some cases, the device is a storage device including, by way of non-limiting examples, CD-ROMs, DVDs, flash memory devices, magnetic disk drives, magnetic tapes drives, optical disk drives, and cloud computing based storage. In some cases, the storage and/or memory device is a combination of devices such as those disclosed herein.

In some cases, the classical computer includes a display to send visual information to a user. In some cases, the display is a cathode ray tube (CRT). In some cases, the display is a liquid-crystal display (LCD). In some cases, the display is a thin-film-transistor liquid-crystal display (TFT-LCD). In some cases, the display is an organic light-emitting diode (OLED) display. In some cases, an OLED display is a passive-matrix OLED (PMOLED) or active-matrix OLED (AMOLED) display. In some cases, the display is a plasma display. In some cases, the display is a video projector. In some cases, the display is a combination of devices such as those disclosed herein.

In some cases, the classical computer includes an input device to receive information from a user. In some cases, the input device is a keyboard. In some cases, the input device is a pointing device including, by way of non-limiting examples, a mouse, trackball, trackpad, joystick, game controller, or stylus. In some cases, the input device is a touch screen or a multi-touch screen. In some cases, the input device is a microphone able to capture voice or other sound input. In some cases, the input device is a video camera or other sensor able to capture motion or visual input. In some cases, the input device is a Kinect® or Leap Motion®. In some cases, the input device is a combination of devices such as those disclosed herein.

### Opto-Electronic Systems for Simulating a Solution to an SDE

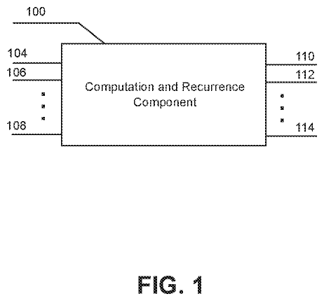

Now referring to FIG. 1, there is shown a diagram of an opto-electronic system for simulating at least one solution of a stochastic differential equation (SDE) driven by a Levy process wherein the stochasticity of the Levy process is represented by photon statistics of at least one optical mode. A stochastic differential equation (SDE) may be a system of differential equations in which one or more of the terms are stochastic processes. A stochastic process may be a mathematical object defined as a family of random variables. These differential equations may describe the dynamics of the system variables for a single run of the system.

As disclosed herein, the stochasticity of a Levy process may be represented by photon statistics of at least one optical mode. An optical mode may be a quantum or classical state of an electromagnetic field with wavelengths ranging from infrared to the end of visible light. An optical mode may be represented by an optical pulse that propagates in an optical waveguide, where the amplitude of the optical pulse may represent the variables of the underlying problem or model. A quantum optical mode is an optical mode that possesses quantum characteristics.

Examples of a quantum optical mode are squeezed states and photon-number (Fock) states. A squeezed states may be a squeezed coherent states which is an optical coherent state whose variance in the position or momentum quadrature is squeezed (or anti-squeezed). The quantum optical mode in a squeezed state is a quantum optical mode that has less than the minimum quantum noise level in one quadrature and more than the minimum quantum noise level in the conjugate quadrature, maintaining the uncertainty principle.

As illustrated in FIG. 1, the opto-electronic system comprises at least one input port 104, 106, . . . , 108 for receiving at least one optical mode, a computation and recurrence component 100, and an output port 110, 112, . . . , 114 for readout.

In some cases, a stochastic differential equation (SDE) driven by a Levy process is of the form

dx(t)ᵢ=f(x(t)ᵢ,t)dt+g(x(t)ᵢ,t)dZ(t)ᵢ

wherein Z(t) is a Levy process. The Levy process may be the Wiener process, the Poisson process, the gamma process, the Pascal process, the Cauchy process, or the Meixner process. The Levy process may be any stochastic process which satisfies the mathematical definition of a Levy process.

In some cases, the stochastic differential equation is of the form

dxᵢ=f(xᵢ,t)dt+g(xᵢ,t)dWᵢ,

wherein dW is the derivative of the Wiener random process. This type of the stochastic differential equation may also be referred to as a forward stochastic differential equation. The first term, called the drift coefficient, effectively provides a drift force to the evolution of the stochastic processes x(t). The diffusion coefficient g(x, t) provides randomness. The choice of a drift coefficient and a diffusion coefficient collectively is referred to as a stochastic differential equation in this embodiment.

In some cases, the stochastic differential equation represents Langevin dynamics comprising the gradient descent and a noise term, written as

dcᵢ=−∂ᵢf(c)dt+σdWᵢ, ∀i∈{1, . . . , N}.

While the first term represents the gradient of the objective function and drives the variables towards the minimum of the objective function, the second term makes the process stochastic to increase the chance of finding the global minimum. Here, c is a vector of variables, σ is a constant, dW is the derivative of the Wiener random process, N is the number of variables, and ∂ indicates a partial derivative with respect to a member of c.

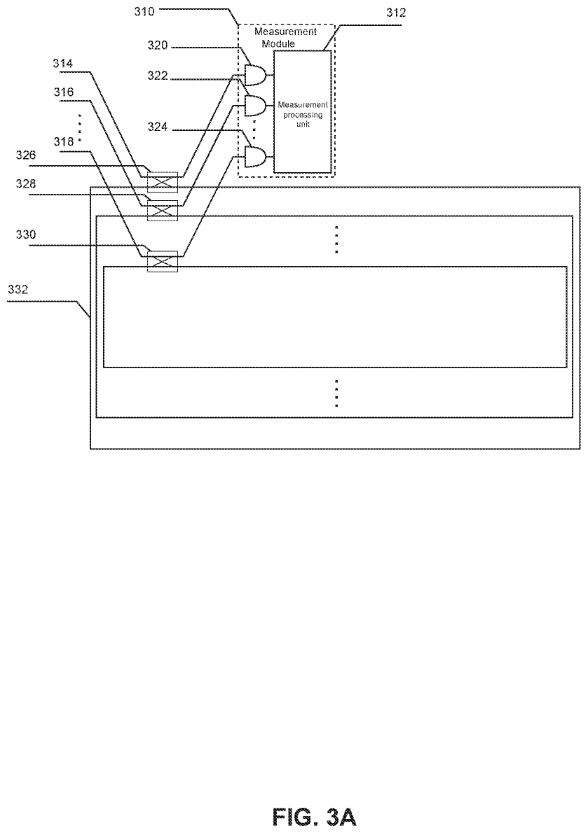

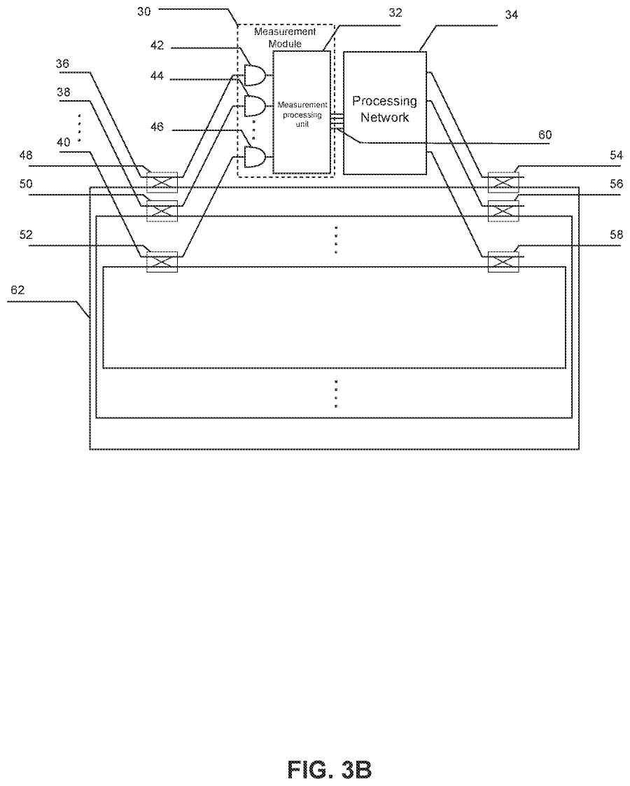

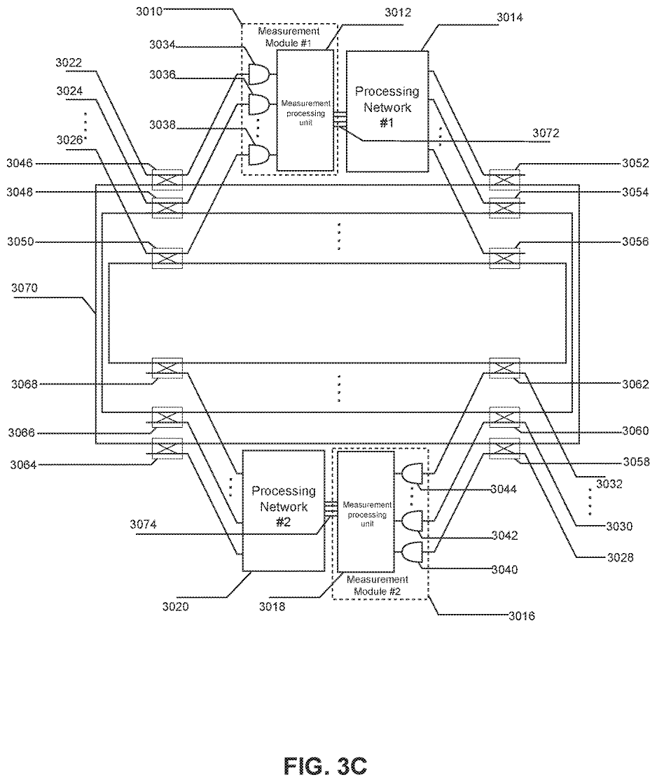

The SDEs described elsewhere herein representing the underlying process of the optical devices and systems disclosed herein assume the system is at zero temperature. While physically this may not be feasible, it represents an accurate approximation of the conditions of the actual system, such as the opto-electronic system described herein with respect to FIG. 3A, FIG. 3B, FIG. 3C, and FIG. 1. At a nonzero temperature, the underlying process may include a noise arising from the effect of quantum measurement performed by the environment on the system, which is reflected in the corresponding SDEs.

The signals representative of the variables and of the one or more parameters of the SDE may be optical signals or electronic signals. In the embodiments wherein the signals are electronic, they may encode information using a current pattern or using a voltage pattern. The pattern may include variations in amplitude, duration, phase, or shape of the current signal or voltage signal. The electronic signals representative of the variables and of the one or more parameters of the SDE may be generated by electronic signal generators such as voltage sources or current sources, or from optical-to-electronic conversion of optical signals. Optical-to-electronic conversion may be achieved by using photodetectors. In some cases, wherein the signals are optical, they may encode information using the amplitude and phase of a series of optical pulses to represent variables or parameters of the SDE. The optical pulses may be generated using a continuous-wave laser source that has been modulated using a periodic microwave signal to generate a train of optical pulses. The laser may be turned on and off at a specific rate to generate optical pulses that are separated in time but have the same wavelength as that of the laser source.

The at least one input port 104, 106, 108 is for receiving at least one optical mode. The at least one optical mode may be of various types. In some cases, the at least one optical mode is a quantum optical mode. In some cases, the at least one optical mode comprises a squeezed state. In some cases, the at least one optical mode comprises a vacuum state. In some cases, the at least one optical mode comprises a coherent state. The at least one optical mode may comprise a vacuum state converted into a squeezed state using the computation and recurrence component 100. Vacuum states may be injected by leaving the at least one input port, as described elsewhere herein, open. By leaving the at least one input port open, the vacuum states of light may be injected into the system. A squeezed vacuum state may be generated externally using a squeezing device that receives strong coherent light (e.g., from a laser source) and generates a squeezed vacuum state. Then, the output of the squeezing device may be fed into the at least one input port of the opto-electronic system. Squeezed vacuum states may have greater uncertainty in one of the quadratures of the optical field (e.g., the real part of the optical field) and less uncertainty in the conjugate quadrature. This is a purely quantum effect where the uncertainty may be below the minimum uncertainty in one of the quadratures. Compared to a vacuum state, a squeezed vacuum state may have greater quantum noise which may be used to control the stochasticity of the Levy process more freely compared to the vacuum state injection. Coherent states of light may also be injected into the at least one input port of the opto-electronic system. Coherent states are classical states of light with a minimum quantum noise limit, where the photon statistics in the at least one optical mode may be used to generate stochasticity. Coherent states may be generated using an external laser source and fed into the at least one input port of the opto-electronic system. The amount of squeezing of the squeezed state may control the stochasticity (i.e., noise) of a quantum optical mode. By continuously injecting controllable squeezed states into the opto-electronic system, the randomness in the stochastic differential equation (SDE) may be controlled. The greater the amount of squeezing is, the greater is the variance of the randomness added to the pulses. This injection may happen continuously during each round trip of the pulses in the opto-electronic system, or once every few iterations. In some cases, the at least one optical mode is programmable. The at least one optical mode may be quantum, meaning that there is quantum entanglement between the optical modes.

In some cases, a plurality of quantum optical modes may be injected as squeezed vacuum states using squeezers, or as coherent states using external laser sources. These laser sources may operate at the same wavelength as the rest of the opto-electronic system. A single laser source may be used to generate pulses of different amplitudes by dynamically controlling the power of the laser or by continuously using an intensity and a phase modulator to create the required initial amplitudes and phases of the optical pulses. The chain of pulses generated by the laser can then be synchronized using a network of delay lines, so all the pulses on different optical lines arrive at the opto-electronic system. A delay line system may be a system comprising a set of optical waveguides, intensity modulators, phase modulators, and beam splitters. This system may be used to create coupling between pairs of input optical pulses by delaying the optical pulses and adjusting their amplitudes and phases accordingly. The optical pulses generated by the laser are all in the same optical mode but with different parameters. Each optical pulse is an independent optical mode from the rest of the optical pulses, but all have the features of the same optical mode that is created using the same laser source or the same squeezer.

The computation and recurrence component 100 may be configured to perform one or more operations on one or more signals derivative of the at least one optical mode to simulate the at least one solution to the stochastic differential equation. The one or more signals derivative of the at least one optical mode may be of various types. The one or more signals derivative of the at least one optical mode may be optical pulses, opt-electronic signals, electronic signals, digital signals, or analog signals as described elsewhere herein.

The computation and recurrence component 100 comprises one or more of: a digital electronic component, an analog electronic component, an opto-electronic component, and an optical component. The components may be fabricated and connected to each other through a single integrated-circuit manufacturing process, leading to a single application-specific integrated circuit (ASIC). The components may also be fabricated and connected to each other through a heterogeneous manufacturing process, wherein various individual components or groups of components are individually manufactured, possibly through different manufacturing technologies, and then assembled. In the heterogeneous approach, the components or groups of components may be obtained from commercially available catalogues, or they may be specifically designed into an integrated circuit to achieve specific requirements. The digital and analog electronic components described above are often built using CMOS technology, especially in the case of integrated circuit implementations. However, components such as diodes and transistors can also be fabricated using other monolithic fabrication processes and circuit design. These include, but are not limited to, bipolar junction transistor (BJT), silicon-on-insulator (SOI), bipolar CMOS (BiCMOS) technologies, and other fabrication technologies for analog, digital, and mixed-signals (combined analog and digital circuits) applications.

The analog electronic component may comprise a resistive random-access memory (RRAM) device. The digital electronic component may comprise a field-programmable gate array (FPGA). In some cases, the computation and recurrence component 100 comprises one or more analog electronic components, wherein one or more of those analog electronic components is used to amplify or reshape the signal to compensate for the losses occurring in the system.

The optical modes may be converted to digital signals using optical analog-to-digital converters (ADC) and back from digital signals to optical modes using optical digital-to-analog converters (DAC). The analog electronic signals may be converted to digital signals using electronic ADCs and back from digital signals to analog electronic signals using electronic DACs. These converters may be realized on-chip together with the FPGA or used externally using separate DAC or ADC devices. The analog optical modes may be converted to analog electronic signals and back using opto-electronic components incorporating opto-electronic materials, such as lithium niobate, wherein an electronic signal can alter the optical properties of the opto-electronic material.

In some cases, the computation and recurrence component 100 comprises one or more optical components, wherein the at least one of the one or more optical components comprises at least one coupler. The at least one coupler may receive an optical mode via an input port of the at least one of the one or more optical components. The one or more optical components may be of various types, such as beam splitters, directional couplers, phase shifters, amplifiers, squeezers, or nonlinear optical components. A beam splitter may take a portion of an optical pulse to perform measurements or other operations on it. It may also be used to implement unitary operations on quantum optical modes. A phase shifter may be used to adjust the phase of the optical pulses to maintain their coherence during their couplings or as part of the implementation of a unitary operation. An amplifier may be used to compensate for the losses occurring in the system by coherently pumping the optical pulses. A squeezer may be used to adjust and control the fundamental noise level of the optical pulses in order to adjust the performance of the system. In some cases, the optical components include at least one nonlinear optical component. These components may incorporate optical nonlinearity of the second or third order in order to implement non-Gaussian optical interactions. These interactions may be necessary for implementing mathematical functions that are nonlinear (e.g., quadratic, cubic, or quartic). Such mathematical functions may be necessary for creating the correct drift term of the stochastic differential equation using optical elements.

The at least one coupler may be of various types. In some cases, the at least one coupler is a tunable coupler. The tunable coupler may be capable of having a variable transmission coefficient, meaning that the amount of the optical field transmitted to a particular output of the coupler may be variable and may be controlled. In some cases, the at least one coupler is a tunable coupler comprising a Mach-Zehnder interferometer (MZI). An MZI may be made up of two 50:50 beam splitters and two phase shifters, where by changing the amount of phase shift on the phase shifters a tunable coupling may be realized. The computation and recurrence component may comprise an MZI mesh comprising a network of MZIs. An MZI mesh is a network of MZIs where a matrix-vector multiplication operation is performed by creating couplings between the input optical modes using a network of connected MZIs. The MZI mesh may have any configuration, including a triangular or a rectangular configuration. Such an MZI mesh is reconfigurable by adjusting the two phase shifters in each MZI within the MZI mesh. The parameters of the MZI mesh may continually or continuously be tuned with time. The triangular configuration of the MZI mesh may be implemented similarly to the approach presented in the paper “Experimental realization of any discrete unitary operator.”, Reck et al. Physical review letters 73.1 (1994): 58, which is incorporated herein by reference for all purposes, whereas the rectangular configuration may be implemented similarly to the approach presented in the paper “Optimal design for universal multiport interferometers.”, Clements et al. Optica 3.12 (2016): 1460-1465, which is incorporated herein by reference for all purposes. The tunable coupler may also be realized using other methods incorporating table-top optical components.

In some cases, the at least one coupler is a fixed coupler such as a beam splitter. A fixed coupler has a fixed ratio between the amplitudes of the two outputs of the coupler. This ratio may be 50:50, meaning that equal amounts are transmitted to the two outputs. This ratio may be 20:80, meaning that the transmission ratio between the two outputs of the coupler is 20% and 80%. This ratio may be of any other fixed value.

In some cases, the computation and recurrence component 100 comprises a free-space analog optical matrix-vector multiplication (MVM) unit. Such an MVM unit may be created from an array of intensity and phase modulators, where the amplitude and phase of a free-space optical pulse is manipulated using the modulators. The modulators may be electro-optical components where, by applying and changing an electrical signal, the intensity and phase of the optical pulse that is passing through may be changed. Each of N rows of optical pulses representing a variable of the underlying problem may be divided into N columns of optical pulses with identical amplitudes and phases to create an array of N×N optical pulses. These pulses may then be fed into an N×N array of modulators. The output of the modulators may then be collected into N columns by adding optical pulses on the rows of each column of the N×N optical outputs to generate the output of the MVM as a vector of N optical pulses. The result may then be fed back into the rest of the opto-electronic system through couplers. The parameters of the modulators may be determined by the elements of the matrix used for the MVM operation.

In some cases, the computation and recurrence component 100 comprises nonlinear optical or electronic elements. These nonlinear elements may be capable of implementing a mathematical function that is a nonlinear function of the input optical or electronic signals. The nonlinearity of these components may be of second-order quadratic form. The nonlinearity of these components may be of any other nonlinear form. In some cases, the optical nonlinearity is generated using nonlinear optical materials (e.g., lithium niobate) with strong second-order or third-order optical nonlinearity. In some cases, the optical nonlinearity is generated using photodetectors. The photodetectors may generate an electronic signal that is proportional to the intensity the optical mode receives, which in turn is proportional to the square of the amplitude of the optical field. An electronic signal that is a quadratic function of the optical mode's amplitude may be generated in such a way. The electronic signal may then be processed using analog electronic components, converted to a digital electronic signal, or converted to an optical mode using an optical intensity modulator. The optical nonlinearity may also be generated using other methods. In some cases, the nonlinearity is generated using analog electronic circuits composed of at least one of analog multipliers, amplifiers, potentiometers, or function generators. The electronic components forming such analog electronic circuits may comprise diodes, transistors, differential amplifiers such as operational amplifiers, and passive components such as resistors, inductors, and capacitors. The mathematical operations performed by such analog electronic circuits to compute a nonlinear function of the input signal may comprise addition, integration, inversion, multiplication, exponentiation, logarithmic computation, and division. A nonlinear function may also be generated by a crossbar array of memristive devices (or other RRAM devices) implementing a matrix-vector multiplication between a vector of input signals and an appropriately valued matrix mapped to the conductance states of the memristive devices (or other RRAM devices). Such conductance states of the memristive devices may be programmed with electronic signals. Nonlinear outputs may be computed with analog components such as differential amplifiers. An analog electronic signal may be converted to optical modes and back using opto-electronic components. By using opto-electronic materials, these components are capable of modulating the optical modes with an electronic signal. They are also capable of generating an analog electronic signal using an input optical mode using the same process.

In some cases, a photonic integrated circuit, an electronic integrated circuit, and a memristor chip comprising a crossbar array of memristive devices (or other RRAM devices) is assembled and interconnected on a silicon interposer or an advanced organic substrate to form a multi-chip computation and recurrence component 100.

In some cases, the computation and recurrence component 100 comprises a measurement module for performing a homodyne measurement of the at least one optical mode. The measurement module may comprise homodyne detection devices for performing homodyne measurements of optical modes. By measuring the intensity of an optical field, and comparing its phase to a reference phase, the results of homodyne measurements may be used to infer the results of performing quantum measurements in the position or momentum basis. The homodyne detection device may comprise a beam splitter where the optical mode to be measured is fed into one input and the field from the local oscillator (e.g., a laser source) is fed into another input. The outputs of the beam splitter may then be connected to two separate photodetectors which measure the intensity of the input optical fields. The output electronic signals of the photodetectors may then be subtracted using an electronic device and the amplitude and phase of the optical mode may be inferred. The measurement module may comprise a measurement processing unit. The measurement processing unit may receive the electronics signals output from the homodyne detectors and may perform some processing on these signals. This processing may be of various types. It may be a conversion of analog electronic signals to analog optical signals. It may be a conversion of analog electronic signals to digital electronic signals. The processing unit may implement an identity function on the results of the measurements, meaning that the analog electronic signals may be unaltered and used as is. In some cases, the measurement module comprises a memory to store the measurement results. The memory may be implemented electronically within a digital processing unit or an analog processing unit inside the measurement module. In some cases, the measurement module comprises other opto-electronic devices to convert the optical energy into electronic signals for digital or analog processing. Such devices are capable of performing quantum measurements on the quadratures of quantum optical modes, similarly, to performing homodyne measurements.

A quantum measurement may be of any type, including photon counting, homodyne measurement, heterodyne measurement, and photon-number-resolving (PNR) measurement. Photon counting measurement may be performed by using photodetectors wherein an electrical photocurrent is produced that is proportional to the number of photons in an optical mode. Homodyne measurement may be performed by combining the optical field of the signal with that of a local oscillator (e.g., a laser source) using a beam splitter and performing photodetection on one or both of the outputs. In the case of measuring both outputs, the subtraction of the photocurrents from the two photodetectors may provide the measured value of a given quadrature of the optical field. Heterodyne measurement may be performed similarly to homodyne measurement by measuring two conjugate quadratures of the optical field simultaneously using two homodyne measurements that are 90 degrees out of phase or by detuning the local oscillator field. Photon-number resolving measurement may be performed similarly to photon counting measurement, where the detectors are designed to have greater accuracy with respect to the number of photons that arrive at the detector. The output of these quantum measurements may be an analog electronic signal which can be used as is, converted to an optical signal, or converted to a digital electronic signal for further operation or processing. The quantum measurement may be performed weakly by the environment in the low-photon regime, in which case the couplers may represent the photon loss into a reservoir.

In some cases, the stochasticity is controlled using quantum measurements. In some cases, a quantum measurement changes photon statistics of one or more optical modes of the at least one optical mode. In some cases, a quantum measurement of an optical mode of the at least one optical mode creates an optical mode with photon statistics different from that of the measured optical mode. This may be performed by generating another optical mode, externally or internally, with photon statistics that are intrinsically different from that of the measured optical mode, but with parameters that are determined by the measured properties of the measured optical mode. In such cases, the newly generated optical mode has photon statistics that are different from the originally measured optical mode, but it is dependent on the measured properties of the measured optical mode.

In some cases, the computation and recurrence component 100 comprises a feedback loop. In some cases, the feedback loop comprises an electronic component. In some cases, the feedback loop comprises an optical component. In some cases, the opto-electronic system comprises optical waveguides. The optical waveguides may be of various types. In some cases, the optical waveguides comprise optical fibre.

A measurement-feedback system may be a system comprising different components, including a homodyne measurement system, digital-to-analog converters, analog-to-digital converters, and a classical computing device. This system may be used to measure the amplitudes of the input optical pulses and generate output optical pulses that are functions of other input optical pulses, to create couplings between the input optical pulses.

In some cases, the computation and recurrence component 100 comprises a signal aggregator for adding signals. In some cases, the signal aggregator comprises a circuit node. The circuit node may operate based on Kirchoff's law of electrical circuits, where the total electrical current output at a node is equal to the total electrical current input at the node. In some cases, the signal aggregator comprises a summing amplifier circuit. The summing amplifier circuit may produce a voltage output that is proportional to the sum of the voltage inputs provided at its one or more input ports. In some cases, the signal aggregator comprises one or more optical components comprising at least one coupler. The optical signal aggregator may operate by feeding input optical pulses into the two input ports of an optical coupler, and the outputs of the coupler may be proportional to the addition or the subtraction of the two input pulses. For adding or subtracting more than two optical pulses, two or more optical couplers may be used where the number of couplers is proportional to the number of optical pulses being added or subtracted.

In some cases, the computation and recurrence component 100 comprises a processing network. The processing network's output may at least in part be representative of a drift term of the stochastic differential equation (SDE). In some cases, the processing network generates at least one programmable optical mode. In some cases, the at least one generated programmable optical mode is at least in part representative of a drift term of the stochastic differential equation. In some cases, the at least one generated programmable optical mode may be in a coherent state with its amplitude modulated by a value representative of the drift term. The coherent state may be generated using an intensity modulator (IM) wherein the optical field from a local oscillator is modulated with a value that is determined by the processing network 34. In some cases, the at least one generated programmable optical mode may be in a squeezed state with its amplitude modulated by a value representative of the drift term. The programmable squeezed state may be generated by coupling a modulated coherent state with a squeezed vacuum state using a beam splitter or a coupler. The squeezed vacuum state may be generated externally using an optical squeezer. In some cases, the at least one generated programmable optical mode may be quantum, meaning that there is quantum entanglement between the optical modes representing the variables and one or more parameters of the model. The at least one generated programmable optical mode may include terms that represent a nonlinear function of the measured optical mode amplitudes \tilde{μ}ᵢ which are random variables. In this case, such terms represent a nonlinear form of randomness (i.e., stochasticity) in the stochastic differential equations. They may be represented as g(xᵢ, dWᵢ, t) in the stochastic differential equation disclosed with respect to FIG. 3A, namely, the coefficient g being dependent on the Wiener process dWᵢ.

The processing network output may at least in part be representative of randomness (i.e., stochasticity) of the stochastic differential equation (SDE). The randomness may be generated using results of homodyne measurement of the at least one optical mode.

In some cases, the computation and recurrence component 100 comprises a function approximator comprising one or more parameters and receiving one or more variables as inputs. In some cases, wherein the computation and recurrence component 100 comprises a processing network, the processing network comprises a function approximator. The one or more parameters may be determined analytically and set prior to processing. The one or more parameters may be determined continually or continuously by training a processing network. The one or more input variables may be received as input signals. They may be received as digital signals for a function approximator created using a digital processor (e.g., an FPGA). The one or more input variables may be received as electronic signals for a function approximator that is created using optical or analog electronic components. The one or more input variables may be received as optical modes for a function approximator that is created using optical components. The one or more input variables of the function approximator may be received as optical modes. The one or more input variables of the function approximator may be received as electronic signals received from the output of the measurement system. The function approximator may be trained for approximating the score function of a machine learning model. The function approximator may be able to implement the exact mathematical form of the score function or a polynomial approximation thereof. The score function Se is the gradient (with respect to a random variable, i.e., the data) of the log-likelihood of the probability density function, that is, s_{θ}(x, t)=∇ₓ log p(x,t). As it is a gradient, it provides a measure of the change in the log-likelihood given an infinitesimal change in the data. As such, having an accurate score function may guide a stochastic process toward maximizing the log-likelihood and thus generating samples of maximum likelihood, which is the goal of generative machine learning.

Machine learning (ML) may be a combination of an architecture (e.g., a model), numerical parameters, and a method used to tune (i.e., train, or learn) the values of the parameters so that the model may carry out a prespecified task. In some cases, a machine learning model may be a generative machine learning model. Generative machine learning may be a subfield of machine learning concerning learning a model for the probability distribution from which a training dataset originates or learning to sample from the probability distribution from which a training dataset originates.

Generative machine learning models may be grouped into implicit density and explicit density models. With implicit density models, such as generative adversarial networks (GAN), presented in “Generative Adversarial Networks” Goodfellow et al., arXiv: 1406.2661, which is incorporated by reference herein for all purposes, one does not care about learning the actual probability density function underlying a dataset, but rather aims to learn a procedure that can produce samples from this probability density function. With explicit density models, comprising denoising diffusion probabilistic models (DDPM) (presented in “Deep Unsupervised Learning using Nonequilibrium Thermodynamics” Sohl-Dickstein, et al., Proceedings of the 32nd International Conference on Machine Learning, PMLR 37:2256-2265, 2015, which is incorporated by reference herein for all purposes,), variational autoencoders (presented in “Auto-encoding Variational Bayes” Kingma & Welling, arXiv:1312.6114, which is incorporated by reference herein for all purposes,), Boltzmann machines (presented in “Restricted Boltzmann machines for collaborative filtering” Salakhutdinov, et al., Proceedings of the 24th International conference on Machine learning, ICML '07:791-798, 2007, which is incorporated by reference herein for all purposes,), and PixelCNN (presented in “Conditional image generation with PixelCNN decoders” van den Oord, et al., arXiv:1606.05328, which is incorporated by reference herein for all purposes,), the aim is to learn a representation for the probability density function explicitly. Having access to the probability density itself may be useful in situations where its analysis is more meaningful than are individual samples (e.g., the wavefunction in quantum mechanics), or in applications where interpreting likelihood can be useful, such as anomaly detection.

A latent variable may be an intermediate transformation of input data into a different, latent space. The latent space may be of different dimensionality than the input data, such as the lower-dimensional, compressed space used in autoencoders. The latent space is usually continuous, whereas the input data may not be continuous, for example, images. Latent representations may be used in machine learning methods.

Training may be the process of tuning a machine learning (ML) model's tunable parameters such as a neural network's tunable parameters, for example, weights and biases, so as to improve the performance of the ML model by providing it with training data. Tunable parameters may be one or more of the trainable/learnable parameters of a machine learning (ML) model such as a neural network model. Training data may be data that used to improve a machine learning (ML) model, for example, an ML model such as a neural network, using data that may differ from the training data.

In some cases, the function approximator is trained for approximating a function representative of the log of the probability distribution of the data of a machine learning model. In such an embodiment, the function approximator is not representative of the score function itself, and an extra step to evaluate the gradient (e.g., via finite differences) may be used to compute the gradient and thus the score function. This embodiment may have the benefit of providing access to the likelihood function directly, which may be in itself desirable for modelling purposes.

In some cases, the function approximator is trained for approximating the gradient of a function representative of the log of the probability distribution of the data of a machine learning model. In such an embodiment, the output of the function approximator may be directly considered to be the score function, with no additional steps needed to evaluate the gradient.

In some cases, the function approximator comprises a neural network. In some cases, the neural network approximates the drift term of the stochastic differential equation and is used to generate such a drift term. The neural network may be of various types. In some cases, the neural network is an optical neural network, implemented using optical components. The optical neural network may comprise any or a combination of optical components such as phase shifters, beam splitters, phase-sensitive amplifiers, squeezers, and other linear and nonlinear optical elements. In some cases, the neural network is an analog opto-electronic system implemented using a combination of linear optical components, such as beam splitters, phase shifters, or optical squeezers, and nonlinear optical components such as a phase-sensitive amplifier or any other nonlinear optical components incorporating nonlinear optical crystals or opto-electronic materials. The parameters of these components may be controlled externally by controlling the electronic signals that control the optical properties of these components. In some cases, the neural network is an analog electronic system implemented using crossbar arrays of resistive memories (or other RRAM devices) in combination with analog electronic components, such as transistors, operational amplifiers, transimpedance amplifiers, analog switched capacitor circuits, analog passive delay lines, and other resistive and capacitive elements. In some cases, the neural network is analog electronic. The analog electronic system implementing the neural network may comprise circuits providing nonlinearities. These nonlinearities may be generated using analog electronic circuits as disclosed elsewhere herein. In some cases, the neural network is implemented using a combination of analog electronic and analog optical components. The analog components may be any combination of the optical and electronic components disclosed elsewhere herein. The optical modes may be converted to electronic signals and back using converters that are implemented using opto-electronic materials.

In some cases, the neural network is digital, implemented using a digital computing device (e.g., a digital computer or a field-programmable gate array (FPGA)). The digital computer may be of various types. The digital computer may be any digital computer disclosed elsewhere herein. The parameters of the neural network may be pre-programmed (e.g., during inference) or may be dynamically controlled using external parameters such as the results of the measurement system (e.g., during training).

In some cases, the neural network is analog electronic. The analog electronic system implementing the neural network may comprise circuits providing nonlinearities. These nonlinearities may be generated using analog electronic circuits as described elsewhere herein.

In some cases, the measured results from the measurement of the opto-electronic system are interpreted as a latent encoding of input data for use in machine learning methods. In such cases, the opto-electronic system may be initialized to the input data. The opto-electronic system may then be evolved according to the stochastic differential equation that describes the dynamics of the optical device. The state of the optical device may then be measured. The measurement is thus a stochastic transformation of the original input data with the transformation process being carried out by the opto-electronic system. This transformed input data may be stored and then used as input to a machine learning method. For example, it may be used for training of the score function approximator in generative machine learning diffusion models.

In some cases, wherein the computation and recurrence component 100 comprises a processing network, the processing network is used to implement an arbitrary function. If the function is a linear function of the input variables, linear operations may be used to implement the function. If the function is nonlinear, a combination of the linear operations and the nonlinear operations disclosed herein with respect to the processing network 34 of FIG. 3B may be used to implement the nonlinear function exactly or approximately. The implemented arbitrary function may be the gradient of an objective function representing an optimization problem. The implemented arbitrary function may be any function of the gradient of the objective function. The arbitrary function may be a function of the variables from previous steps of the Euler method.

The Euler method may be an integration method for solving stochastic differential equations (SDE), where, starting from values of zero, the variables of an SDE are updated by the differential changes obtained from the SDEs. This process may be repeated an arbitrary number of times until a value for the variables is reached. The coherent optical networks may approximately implement the Euler method by recursively updating the optical pulses' amplitudes an arbitrary number of times with differential changes that are represented by an SDE.

In some cases, the processing network includes at least one optical cavity to store the optical pulses and uses them to compute the implemented arbitrary function. The optical cavity may store the optical pulses for as many round trips of the Euler method as needed before using them for the next step of the Euler method.

In some cases, the drift term of the stochastic differential equation comprises the drift term of a reverse stochastic differential equation representative of a reverse diffusion. In some cases, the drift term is representative of an optimization problem. In such cases, the drift term may be representative of an objective function. In some cases, the drift term is representative of the gradient of an objective function. In some cases, the drift term is representative of a function of the gradient of an objective function. In some cases, the drift term is representative of a time-dependent function of the gradient of an objective function that depends on previous times. The drift term may depend on other quantities or outputs from other processes.

In some cases, the optimization problem is the box-constrained quadratic programming problem. In some cases, the natural properties of an optical device are used to implement a box constraint of the problem. In some cases, a processing network is used to implement a box constraint. A box-constrained quadratic programming problem may be a class of non-convex continuous optimization problems with continuous variables that are subject to a lower bound and an upper bound. These problems may generally be written as:

$$minimize f ( x ) = \frac{1}{2} {\sum }_{i , k = 1}^{N} {Q}_{ik} {x}_{i} {x}_{k} + {\sum }_{i = 1}^{N} {V}_{i} {x}_{i}$$

$$subject to {l}_{i} \leq {x}_{i} \leq {u}_{i} , for all i$$

The objective is to minimize the objective function ƒ(x) for the continuous values of xᵢ, subject to the box constraint. The matrix elements Qᵢₖ and the vector elements Vᵢ, together with the lower bounds lᵢ and upper bounds uᵢ, determine an instance of the box-constrained quadratic programming problem.

In some cases, the optimization problem is the maximum-weighted independent set (MWIS) problem, implemented using continuous-variable representation. In some cases, the natural properties of the optical device are used to implement the constraints of the MWIS problem. In some cases, a processing network is used to implement the constraints of the MWIS problem. A maximum-weighted independent set (MWIS) may be a class of non-convex optimization problems in graph theory where the aim is to find an independent set of largest weight among all possible independent sets in a given graph. An independent set within a graph is a set of nodes of the graph where there is no edge between the nodes of the given set. The weight of a set is equal to the sum of the weights of the nodes within that set.

In some cases, the optimization problem is the quadratic assignment problem (QAP). In some cases, the natural properties of the optical device are used to implement the constraints of the QAP. In some cases, a processing network is used to implement the constraints of the QAP. A quadratic assignment problem (QAP) may refer to a class of non-convex optimization problems with the goal of assigning a set of n facilities to a set of n locations. For each pair of facilities, a weight (or flow) is specified, and for each pair of locations a distance is specified. The objective is to assign all facilities to different locations with the aim of minimizing the sum of the distances multiplied by the weights (or flows).

The output port 110, 112, . . . , 114 for readout may be of various types. In some cases, the output port 110, 112, . . . , 114 comprises optical waveguides such as optical fibres or on-chip photonic waveguides, or free-space optical propagation where the output of the computation and recurrence component 100 is coupled to free space. In some cases, the output port 110, 112, . . . , 114 comprises electronic circuit components, such as wires, electronic waveguides, resistors, or filtering circuits. The output port 110, 112, . . . , 114 may be analog electronic using electronic waveguides or electrical connections. The output port 110, 112, . . . , 114 may be digital electronic using electrical connections or electronic waveguides. The readout may be of various types. In some cases, the readout results are converted to an image and sent to a display. In some cases, the readout results are stored in a database. In some cases, the outputs of the opto-electronic system are optical fields. In some cases, these optical fields directly generate the pixels of an image without further processing. In some cases, these optical fields are converted to analog electronic signals and kept as is and used for further processing or stored in an analog memory unit for further processing. In some cases, these optical fields are converted to digital electronic signals to store in a database or for further processing. In some cases, the outputs of the opto-electronic system are analog electronic signals. In some cases, these analog signals may be converted to optical modes and used to generate an image or for further processing. In some cases, these analog electronic signals are kept as is and used for further processing or stored in an analog memory unit for further processing. In some cases, these analog electronic signals are converted to digital electronic signals to store in a database or for further processing.

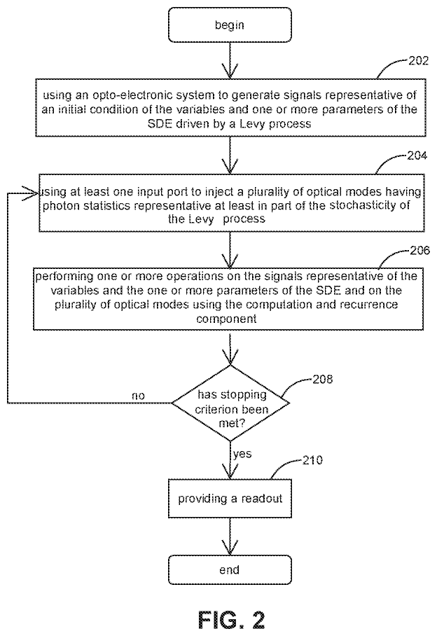

Now referring to FIG. 2, there is shown a flowchart of a method for simulating at least one solution of a stochastic differential equation (SDE) driven by a Levy process wherein the stochasticity of the Levy process is represented by photon statistics of at least one optical mode.

In some cases, the stochastic differential equation (SDE) driven by a Levy process is of the form

dx(t)ᵢ=f(x(t)ᵢ,t)dt+g(x(t)ᵢ,t)dZ(t)ᵢ

wherein Z(t) is a Levy process. The Levy process may be the Wiener process, the Poisson process, the gamma process, the Pascal process, the Cauchy process, or the Meixner process. The Levy process may be any stochastic process which satisfies the mathematical definition of a Levy process.

In some cases, the stochastic differential equation is of the form

dxᵢ=f(xᵢ,t)dt+g(xᵢ,t)dWᵢ,

wherein dW is the derivative of the Wiener random process. This type of the stochastic differential equation may also be referred to as a forward stochastic differential equation. The first term, called the drift coefficient, effectively provides a drift force to the evolution of the stochastic processes x(t). The diffusion coefficient, g(x, t), provides randomness. The choice of a drift coefficient and a diffusion coefficient collectively is referred to as a stochastic differential equation in this embodiment.

In some cases, the stochastic differential equation represents Langevin dynamics comprising the gradient descent and a noise term, written as

dcᵢ=−∂ᵢf(c)dt+σdWᵢ, ∀i∈{1, . . . , N}.

While the first term represents the gradient of the objective function and drives the variables towards the minimum of the objective function, the second term makes the process stochastic to increase the chance of finding the global minimum. Here, c is a vector of variables, σ is a constant, dW is the derivative of the Wiener random process, N is the number of variables, and ∂ indicates a partial derivative with respect to a member of c.

Still referring to FIG. 2 and according to processing operation 202, an opto-electronic system is used to generate signals representative of an initial condition of the variables and one or more parameters of the stochastic differential equation (SDE). The opto-electronic system comprises at least one input port for receiving at least one optical mode, a computation and recurrence component, and an output port for readout. The opto-electronic system may be of various types, such as opto-electronic systems disclosed herein with respect to any of FIG. 3A, FIG. 3B, FIG. 3C, and FIG. 1. The signals representative of the variables and one or more parameters of the SDE may be optical signals or electronic signals. In the embodiments wherein the signals are electronic, they encode information using a current pattern or using a voltage pattern. The pattern may include variations in amplitude, duration, phase, or shape of the current signal or voltage signal. The electronic signals representative of the variables and one or more parameters of the SDE may be generated by electronic signal generators such as voltage sources or current sources, or from optical-to-electronic conversion of optical signals. Optical-to-electronic conversion may be achieved using photodetectors. In the embodiments wherein the signals are optical, they encode information using the amplitudes and phases of a series of optical pulses to represent the variables and one or more parameters of the SDE. The optical pulses may be generated using a continuous-wave laser source that has been modulated using a periodic microwave signal to generate a train of optical pulses. The laser may be turned on and off at a specific rate to generate optical pulses that are separated in time but have the same wavelength as that of the laser source.

Still referring to FIG. 2 and according to processing operation 204, the at least one input port is used to inject a plurality of optical modes having photon statistics representative at least in part of the stochasticity of the Levy process which Levy process drives the stochastic differential equation (SDE). The optical modes may be of various types. In some cases, the optical modes are quantum optical modes. In some cases, the optical modes comprise squeezed states. In some cases, the optical modes comprise vacuum states. In some cases, the optical modes comprise coherent states. The optical modes may comprise vacuum states converted into squeezed states. Vacuum states may be injected by leaving the at least one input port, as described elsewhere herein, open. By leaving the at least one input port open, the vacuum states of light may be injected into the system. A squeezed vacuum state may be generated externally using a squeezing device that receives strong coherent light (e.g., from a laser source) and generates a squeezed vacuum state. Then, the output of the squeezing device may be fed into the at least one input port of the opto-electronic system. Squeezed vacuum states may have greater uncertainty in one of the quadratures of the optical field (e.g., the real part of the optical field) and less uncertainty in the conjugate quadrature. This is a purely quantum effect where the uncertainty may be below the minimum uncertainty in one of the quadratures. Compared to a vacuum state, a squeezed vacuum state may have a greater amount of quantum noise which may be used to control the stochasticity of the Levy process more freely compared to the vacuum state injection. Coherent states of light may also be injected into at least one input port of the opto-electronic system. Coherent states are classical states of light with a minimum quantum noise limit, where the photon statistics in the optical modes may be used to generate stochasticity. Coherent states may be generated using an external laser source and fed into at least one input port of the opto-electronic system. The amount of squeezing of the squeezed state may control the stochasticity (i.e., noise) of a quantum optical mode. By continuously injecting controllable squeezed states into the opto-electronic system, the randomness in the stochastic differential equation (SDE) may be controlled. The greater the amount of squeezing is, the greater is the variance of the randomness added to the pulses. This injection may happen continuously during each round trip of the pulses in the opto-electronic system, or once every few iterations. In some cases, the plurality of optical modes is programmable. The optical modes may be quantum meaning that there is quantum entanglement between the optical modes.

In some cases, a plurality of quantum optical modes may be injected as squeezed vacuum states using squeezers, or as coherent states using external laser sources. These laser sources operate at the same wavelength as the rest of the opto-electronic system. A single laser source may be used to generate pulses of different amplitudes by dynamically controlling the power of the laser or by continuously using an intensity and a phase modulator to create the required initial amplitudes and phases of the optical pulses. The chain of pulses generated by the laser can then be synchronized using a network of delay lines, so all the pulses on different optical lines arrive at the opto-electronic system, such as the ones disclosed with respect to FIG. 3A, FIG. 3B, FIG. 3C, and FIG. 1. These optical lines may be connected to the opto-electronic system using optical cavities similar to the optical cavities disclosed with respect to FIG. 3A, FIG. 3B, FIG. 3C, and FIG. 1. The optical pulses generated by the laser are all in the same optical mode but with different parameters. Each optical pulse is an independent optical mode from the rest of the optical pulses, but all have the features of the same optical mode that is created using the same laser source or the same squeezer.

Still referring to FIG. 2 and according to processing operation 206, one or more operations are performed on the signals representative of the variables and the one or more parameters of the stochastic differential equation (SDE) and on the plurality of the optical modes using the computation and recurrence component, such as the computation and recurrence component 100 disclosed herein with respect to FIG. 1. The one or more operations may be of various types. In some cases, the one or more operations are analog optical operations. In some cases, the operations are digital electronic operations. In some cases, the operations are analog electronic operations. In some cases, the one or more operations include any combination of analog optical operations, digital electronic operations, and analog electronic operations. The one or more operations may include converting a digital electronic signal to an optical mode. The one or more operations may include converting an analog electronic signal to an optical mode. The one or more operations may include converting an analog electronic signal to a digital electronic signal. The one or more operations may include converting a digital electronic signal to an analog electronic signal. The one or more operations may include converting an optical mode to a digital electronic signal. The one or more operations may include converting an optical mode to an analog electronic signal. An optical MZI mesh may be used to perform such an operation as described elsewhere herein. An MVM operation may be performed using free-space optical modulators as described elsewhere herein. An MVM operation may be performed using a crossbar array of memristive devices (or other RRAM devices) as described elsewhere herein. The one or more operations may be nonlinear operations which may be generated optically using second-order or third-order optical nonlinearity, as described elsewhere herein. The one or more operations may be nonlinear operations which may be generated electronically as described elsewhere herein. The one or more operations may be amplitude modulations of the electronic signal, using an amplitude modulator circuit. The one or more operations may be copying or splitting a signal into one or more circuit branches, using a current mirror or splitter circuit. The one or more operations may be subtracting or adding signals, using a current subtractor circuit or differential voltage amplifiers, respectively.

In some cases, the one or more operations may be quantum measurements. A quantum measurement may be of any type, including photon counting, homodyne measurement, heterodyne measurement, and photon number-resolving (PNR) measurement. Photon counting measurement may be performed by using photodetectors wherein an electrical photocurrent is produced that is proportional to the number of photons in an optical mode. By measuring the intensity of an optical field, and comparing its phase to a reference phase, the results of homodyne measurements may be used to infer the results of performing quantum measurements in the position or momentum basis. Homodyne measurement may be performed by combining the optical field of the signal with that of a local oscillator (e.g., a laser source) using a beam splitter and performing photodetection on one or both of the outputs. In the case of measuring both outputs, the subtraction of the photocurrents from the two photodetectors may provide the measured value of a given quadrature of the optical field. Heterodyne measurement may be performed similarly to homodyne measurement by measuring two conjugate quadratures of the optical field simultaneously using two homodyne measurements that are 90 degrees out of phase or by detuning the local oscillator field. Photon-number resolving measurement may be performed similarly to photon counting measurement, where the detectors are designed to have greater accuracy with respect to the number of photons that arrive at the detector. The output of these quantum measurements may be an analog electronic signal which can be used as is, converted to an optical signal, or converted to a digital electronic signal for further operation or processing. The quantum measurement may be performed weakly by the environment in the low-photon regime, in which case the couplers may represent the photon loss into a reservoir.

In some cases, the stochasticity of the stochastic differential equation (SDE) is controlled using quantum measurements. In some cases, a quantum measurement changes photon statistics of one more optical modes of the plurality of optical modes. In some cases, a quantum measurement of one or more optical modes of the plurality of optical modes creates an optical mode with photon statistics different from that of the measured optical mode. This may be performed by generating another optical mode, externally or internally, with photon statistics that are intrinsically different from that of the measured optical mode, but with parameters that are determined by the measured properties of the measured optical mode. In such cases, the newly generated optical mode has photon statistics that are different from the originally measured optical mode, but it is dependent on the measured properties of the measured optical mode.

Still referring to FIG. 2 and according to decision operation 208, if the stopping criterion is met the readout of the state of the opto-electronic system is provided according to processing operation 210. The stopping criterion may be of various types. In some cases, the stopping criterion is the point at which the maximum number of iterations is reached. In some cases, the maximum number of iterations is provided by a user. In some cases, the maximum number of iterations is determined by another method using the current method. In some cases, the other method is a machine learning method or an optimization method disclosed elsewhere herein. The readout may be performed in various ways. In some cases, the readout is performed using homodyne measurement of the optical modes. In some cases, the readout is converted to an image and sent to a display. In some cases, the readout results are stored in a database. In some cases, the output of the opto-electronic system comprises optical fields. In some cases, these optical fields directly generate the pixels of an image without further processing. In some cases, these optical fields are converted to analog electronic signals and kept as is and used for further processing or stored in an analog memory unit for further processing. In some cases, these optical fields are converted to digital electronic signals to store in a database or for further processing. In some cases, the outputs of the opto-electronic system are analog electronic signals. In some cases, these analog signals may be converted to optical modes and used to generate an image or for further processing. In some cases, these analog electronic signals are kept as is and used for further processing or stored in an analog memory unit for further processing. In some cases, these analog electronic signals are converted to digital electronic signals to store in a database or for further processing. If the stopping criterion is not met, the processing operations 204 and 206 are repeated using the at least one input port and the computation and recurrence component of the opto-electronic system, respectively. In the embodiments wherein the signals representative of the variables and the one or more parameters of the stochastic differential equation are optical pulses, the repetition is performed optically using at least one optical cavity. By repeatedly propagating in the optical cavities and the opto-electronic components of the system, the same operations are recursively performed on the optical pulses, all of which may lead to the convergence of the amplitude and phase of the optical pulses towards values representative of a solution of the stochastic differential equation (SDE) driven by the Levy process. The solution of the SDE may be converted to a solution of an optimization problem or a data point from a given distribution of a machine learning model. In some cases, at every repetition, the optical pulses within the optical cavities are amplified using a phase-sensitive amplifier to compensate for the losses of amplitude due to photon loss in the cavities. The optical cavities may be connected to the rest of the opto-electronic system using at least one optical coupler. In the embodiments wherein the signals representative of the variables and the one or more parameters of the stochastic differential equation are electronic signals, the repetition may be performed by using a sample-and-hold circuit to sample and store the output signal and feed it back to the input of the computation and recurrence component, such as the computation and recurrence component 100 disclosed herein with respect to FIG. 1. This sample-and-hold circuit may also perform a normalization of the signal to map the output signal to the appropriate range for input values. The same circuit or a different one may be used to amplify or reshape the signal to compensate for the losses occurring in the system. The circuit may comprise capacitors, transistors, and be controlled by a clock. The clock may be triggered by a digital processing unit such as an FPGA or a digital micro-controller circuit. The clock may also be triggered by an analog ring oscillator circuit or any signal generated in the opto-electronic system. The ring oscillator circuit may include multiple stages and comprise current-starved inverter circuits. The repetition may also be performed by a switched capacitor circuit which stores the output signal in a capacitor and then after a given delay releases the signal back to the input of the computation and recurrence component such as the computation and recurrence component 100 disclosed herein with respect to FIG. 1.

Now referring to FIG. 3A, there is shown a diagram of an opto-electronic system for simulating at least one solution of a stochastic differential equation (SDE) driven by a Levy process wherein the stochasticity of the Levy process is represented by photon statistics of at least one optical mode, the opto-electronic system having optical components.

The opto-electronic system comprises at least one coupler 326, 328, . . . , 330 and a measurement module 310. The at least one coupler 326, 328, . . . , 330 comprises one or more optical components. The at least one coupler 326, 328, . . . , 330 may receive a quantum optical mode via an input port 314, 316, . . . , 318 of at least one of the one or more optical components. The optical components may be of various types, such as beam splitters, directional couplers, phase shifters, amplifiers, squeezers, or nonlinear optical components. The at least one coupler 326, 328, . . . , 330 may be of various types. A tunable coupler is capable of having a variable transmission coefficient, meaning that the amount of an optical field transmitted to a particular output of the coupler may be a variable and may be controlled. In some cases, the at least one coupler 326, 328, . . . , 330 is a tunable coupler such as a Mach-Zehnder interferometer (MZI). An MZI may be made up of two 50:50 beam splitters and two phase shifters, whereby changing the amount of phase shift on the phase shifters the tunable coupling may be realized. A tunable coupler may also be realized using other methods incorporating table-top optical components. In some cases, the at least one coupler 326, 328, . . . , 330 is a fixed coupler such as a beam splitter. A fixed coupler has a fixed ratio between the amplitudes of the two outputs of the coupler. This ratio may be 50:50, meaning that equal amounts are transmitted to the two outputs. This ratio may be 20:80, meaning that the transmission ratio between the two outputs of the coupler is 20% and 80%. This ratio may be of any other fixed value.

The measurement module 310 comprises a homodyne detection device 320, 322, . . . , 324 for performing homodyne measurements of the quantum optical modes. By measuring the intensity of an optical field, and comparing its phase to a reference phase, the results of homodyne measurements may be used to infer the results of performing quantum measurements in the position or momentum basis. The homodyne detection device may comprise a beam splitter, where the optical mode to be measured may be fed into one input and the field from the local oscillator (e.g., a laser source) may be fed into the other input. The outputs of the beam splitter are then connected to two separate photodetectors where they measure the intensity of the input optical fields. The output electronic signals of the photodetectors are then subtracted using an electronic device and the amplitude and phase of the optical mode is inferred. The measurement module 310 comprises measurement processing unit 312. The measurement processing unit 312 receives the electronic signal output from the homodyne detectors and may perform some processing on these signals. This processing may be of various types. It may be a conversion of the analog electronic signals to analog optical signals. It may be a conversion of the analog electronic signals to digital electronic signals. The processing unit may perform an identity function on the results of the measurement, meaning that the analog electronic signals may be unaltered and used as is.

In some cases, the measurement module 310 has a memory to store the measurement results. The memory may be implemented electronically within a digital processing unit or analog processing unit inside the measurement module 310. The measurement module 310 may be operatively optically connected using one or more optical waveguides 332 to the at least one coupler 326, 328, . . . , 330. The one or more optical waveguides 332 may be of various types. In some cases, the one or more optical waveguides 332 are made of optical fibre. The one or more optical waveguides 332 may be free space. In some cases, the one or more optical waveguides 332 may be on-chip photonic waveguides.

In some cases, the measurement module 310 comprises other opto-electronic devices to convert optical energy into electronic signals for digital or analog processing. Such devices are capable of performing quantum measurements on the quadratures of quantum optical modes, similarly to homodyne measurement.

In some cases, the one or more optical waveguides 332 are arranged in a closed optical loop connecting the at least one coupler 326, 328, . . . , 330 and the measurement module 310. The output of the homodyne quantum measurements of the quantum optical modes may be fed back into the at least one coupler 326, 328, . . . , 330. The one or more optical waveguides 332 may be connected directly to the output of the measurement module 310 instead of creating a closed optical loop. The output of the measurement module 310 may also be connected to an input port 314, 316, . . . , 318 of the at least one coupler 326, 328, . . . , 330.

In some cases, the opto-electronic system comprises one or more optical cavities comprising the one or more optical waveguides 332 arranged in a closed loop connecting the at least one coupler 326, 328, . . . , 330 and the measurement module 310. The output of the homodyne quantum measurement of the quantum optical modes may be fed back into the one or more optical cavities. This may be done by connecting the output of the homodyne measurement system to the optical cavity using another set of couplers, arranged similarly to the at least one coupler 326, 328, . . . , 330 on the output side of the measurement module. These couplers may have one input connected to the optical cavity and the other input connected to the output of the measurement module using optical waveguides. The output of these couplers may be connected to the optical cavity.

In some cases, the optical modes within the one or more optical cavities are not in coherent states. This can be the case when squeezed states are injected into a cavity or a nonlinear element is present in a system. In such cases, during the measurement process, by taking a portion of the optical pulses out of the optical cavity, a kick-back noise may be introduced to the portion of the optical pulses that remains within a cavity. The greater the portion of the optical pulse that is taken out, the greater is the noise introduced.

In some cases, the one or more optical cavities may be used as an optical memory. The optical memory may be made of optical cavities of appropriate lengths that are able to store the optical pulses for a duration that is proportional to the length of the optical cavities. The optical cavities may also possess a phase-sensitive amplifier (PSA) to coherently amplify the stored optical pulses of the cavity to compensate for the optical loss while the pulses remain within the cavity.

In some cases, the stochastic differential equation (SDE) driven by a Levy process is of the form

dx(t)ᵢ=f(x(t)ᵢ,t)dt+g(x(t)ᵢ,t)dZ(t)ᵢ

wherein Z(t) is a Levy process. The Levy process may be the Wiener process, the Poisson process, the gamma process, the Pascal process, the Cauchy process, or the Meixner process. The Levy process may be any stochastic process which satisfies the mathematical definition of a Levy process.

In some cases, the stochastic differential equation is of the form

dxᵢ=f(xᵢ,t)dt+g(xᵢ,t)dWᵢ,

wherein dW is the derivative of the Wiener random process. This type of the stochastic differential equation may also be referred to as a forward stochastic differential equation. The first term, called the drift coefficient, effectively provides a drift force to the evolution of the stochastic processes x(t). The diffusion coefficient, g(x, t), provides randomness. The choice of a drift coefficient and a diffusion coefficient collectively is referred to as a stochastic differential equation in this embodiment.

In some cases, the stochastic differential equation represents Langevin dynamics comprising the gradient descent and a noise term, written as

dcᵢ=−∂ᵢf(c)dt+σdWᵢ, ∀i∈{1, . . . , N}.

While the first term represents the gradient of the objective function and drives the variables towards the minimum of the objective function, the second term makes the process stochastic to increase the chance of finding the global minimum. Here, c is a vector of variables, σ is a constant, dW is the derivative of the Wiener random process, N is the number of variables, and ∂ indicates a partial derivative with respect to a member of c.

In some cases, a controllable noise of the quantum optical modes may be generated using quantum measurements of the quantum optical modes. The measurement system comprising the measurement module 310 may introduce a controllable noise to the pulses within the cavity by discarding the out-coupled optical pulses (e.g., for the noising process), or it may measure the out-coupled amplitudes using a homodyne detection device 320, 322, . . . , 324. The measurement module 310 may perform quantum measurement on the quantum optical modes by taking a portion of the optical pulses out of the optical cavity using the at least one coupler 326, 328, . . . , 330, and performing homodyne detection on them (using, e.g., a homodyne detection device 320, 322, . . . , 324). Assuming that the pulses within the cavity are not coherent states, this measurement process introduces a back-action noise on the pulses that remain within the cavity. The controllable noise is representative of at least a portion of the randomness (i.e., stochasticity) of a stochastic differential equation. The pulses measured by the homodyne measurement system (such as a homodyne detection device 320, 322, . . . , 324) provide the values

$${\tilde{μ}}_{i} = {μ}_{i} + \frac{1}{\sqrt{4 j}} \frac{{dW}_{i}}{dt} ,$$

which provide a noise associated with each pulse. Here, \tilde{μ}ᵢ are the measured pulse amplitudes, μᵢ are the amplitudes of the pulses within the cavity, j is the measurement strength, and dWᵢ/dt is the randomness associated with each pulse. If these measured amplitudes \tilde{μ}ᵢ or any function of them are injected back into the input of the at least one coupler 326, 328, . . . , 330, then randomness present in the values of \tilde{μ}ᵢ introduces randomness (i.e., stochasticity) into the stochastic differential equations of the system. In the case wherein the states within the opto-electronic system are coherent states, the SDEs may be written as

$$\frac{d {μ}_{i}}{dt} = - ( 1 + j ) {μ}_{i} + f ( {\tilde{μ}}_{i} ) ,$$

where the stochasticity is introduced through the second term since the argument of the function ƒ is \tilde{μ}ᵢ, which are random variables as shown in the equation disclosed herein.

In some cases, the quantum optical modes are in squeezed states. The amount of squeezing of a squeezed state may control the controllable noise (i.e., stochasticity) of the quantum optical mode. By continuously injecting controllable squeezed states into the opto-electronic system, the randomness in the stochastic differential equation may be controlled. The greater the amount of squeezing is, the greater is the variance of the randomness added to the pulses. A squeezed state may be injected using the at least one coupler 326, 328, . . . , 330. The squeezed states may be generated externally using an optical squeezer and fed into the at least one coupler 326, 328, . . . , 330 using an input port 314, 316, . . . , 318. This injection may happen continuously during each round trip of the pulses around the optical cavity, or once every few iterations.

In some cases, the measurement module 310 models the environment. The quantum measurement may be performed weakly by the environment in the low-photon regime, in which case the at least one coupler 326, 328, . . . , 330 represents the photon loss into a reservoir.

In some cases, the measurement module 310 comprise a digital processing unit where the measurement results are converted into a digital signal and processed. The digital processing unit may comprise a field-programmable gate array (FPGA).

In some cases, the measurement module 310 comprises an analog electronic processing unit where the measurement results are converted into analog electronic signal and processed. The analog electronic processing unit may comprise a resistive random-access memory (RRAM) device.

Now referring to FIG. 3B, there is shown a diagram of an opto-electronic system for simulating at least one solution of a stochastic differential equation (SDE) driven by a Levy process wherein the stochasticity of the Levy process is represented by photon statistics of at least one optical mode, the opto-electronic system having a processing network.

The opto-electronic system comprises at least one coupler 48, 50, . . . , 52, a measurement module 30, and a processing network 34. The at least one coupler 48, 50, . . . , 52 comprises one or more optical components. The at least one coupler 48, 50, . . . , 52 may receive a quantum optical mode via an input port 36, 38, . . . , 40 of at least one of the one or more optical components. The optical components may be of various types such as beam splitters, directional couplers, phase shifters, amplifiers, squeezers, or nonlinear optical components. The at least one coupler 48, 50, . . . , 52 may be of various types. A tunable coupler is capable of having a variable transmission coefficient, meaning that the amount of the optical field transmitted to a particular output of the coupler may be a variable and may be controlled. In some cases, the at least one coupler 48, 50, . . . , 52 is a tunable coupler such as a Mach-Zehnder interferometer (MZI). An MZI may be made up of two 50:50 beam splitters and two phase shifters, where by changing the amount of phase shift on the phase shifters the tunable coupling may be realized. A tunable coupler may also be realized using other methods incorporating table-top optical components. In some cases, the at least one coupler 48, 50, . . . , 52 is a fixed coupler such as a beam splitter. A fixed coupler has a fixed ratio between the amplitudes of the two outputs of the coupler. This ratio may be 50:50, meaning that equal amounts are transmitted to the two outputs. This ratio may be 20:80, meaning that the transmission ratio between the two outputs of the coupler is 20% and 80%. This ratio may be of any other fixed value.

The measurement module 30 comprises a homodyne detection device 42, 44, . . . , 46 for performing homodyne measurements of the quantum optical modes. By measuring the intensity of an optical field, and comparing its phase to a reference phase, the results the homodyne measurements may be used to infer the results of performing quantum measurements in the position or momentum basis. The homodyne detection device is made of a beam splitter where the optical mode to be measured is fed into one input and the field from the local oscillator (e.g., a laser source) is fed into the other input. The outputs of the beam splitter are then connected to two separate photodetectors where they measure the intensity of the input optical fields. The output electronic signals of the photodetectors are then subtracted using an electronic device and the amplitude and phase of the optical mode is inferred. The measurement module 30 comprises measurement processing unit 32. The measurement processing unit 32 receives the electronic signal output from the homodyne detectors and may perform some processing on these signals. This processing may be of various types. It may be a conversion of the analog electronic signals to analog optical signals. It may be a conversion of the analog electronic signals to digital electronic signals. The processing unit may perform an identity function on the results of the measurement, meaning that the analog electronic signals may be unaltered and used as is.

In some cases, the measurement module 30 has a memory to store the measurement results. The memory may be implemented electronically within a digital processing unit or an analog processing unit inside the measurement module 30. The measurement module 30 may be operatively optically connected using one or more optical waveguides 62 to the at least one coupler 48, 50, . . . , 52. The one or more optical waveguides 62 may be of various types. In some cases, the one or more optical waveguides 62 is made of optical fibre. The one or more optical waveguides 62 may be free space. In some cases, the one or more optical waveguides 62 may be on-chip photonic waveguides.

In some cases, the measurement module 30 comprises other opto-electronic devices to convert the optical energy into electronic signals for digital or analog processing. Such devices are capable of performing quantum measurements on the quadratures of quantum optical modes, similarly to homodyne measurement.

In some cases, the one or more optical waveguides 62 is arranged in a closed loop connecting the at least one coupler 48, 50, . . . , 52 and the measurement module 30. The output of homodyne quantum measurements of quantum optical modes may be fed back into the at least one coupler 48, 50, . . . , 52. The one or more optical waveguides 62 may be connected directly to the output of the measurement module instead of creating a closed optical loop. The output of the measurement module may also be connected to an input port 36, 38, . . . , 40 of the at least one coupler 48, 50, . . . , 52.

In some cases, the opto-electronic system comprises one or more optical cavities comprising the one or more optical waveguides 62 arranged in a closed loop connecting the at least one coupler 48, 50, . . . , 52 and the measurement module 30. The output of the homodyne quantum measurement of the quantum optical modes may be fed back into the one or more optical cavities. This may be done by connecting the output of the homodyne measurement system to the optical cavity using another set of couplers, arranged similarly to the at least one coupler 48, 50, . . . , 52 on the output side of the measurement module. These couplers may have one input connected to the optical cavity and the other input connected to the output of the measurement module using optical waveguides. The output of these couplers may be connected to the optical cavity.

In some cases, the measurement module 30 does not perform quadrature measurement on the optical pulses. In such cases, the pulses outcoupled using the at least one coupler 48, 50, . . . , 52 may be fed directly into the processing network 34, bypassing a homodyne detection device 42, 44, . . . , 46. The input pulses of the processing network 34 in this case may be analog optical pulses.

In some cases, the measurement module 30 does not feed the results from the quadrature measurement to the processing network 34. In such embodiments, a homodyne detection device 42, 44, . . . , 46 may be used to measure and determine the values of the variables of the underlying problem at the end of the process, while feeding part of the outcoupled optical pulses from the optical cavities directly into the processing network 34 using the connections 60. Such a system may implement an embodiment wherein all of the processing is performed optically and a homodyne detection device 42, 44, . . . , 46 is used to evaluate the values of the optical pulses at the end of the process.

In some cases, the measurement module 30 is not connected to the processing network 34. In such cases, the connections 60 are disconnected. These embodiments may represent the case when the measurement module 30 is used to evaluate the values of the variables of the underlying problem at the end of the process, and the parameters of the processing network 34 are predetermined or evaluated at each step without using the values of the optical pulses at each step.

In some cases, the optical modes within the one or more optical cavities are not in coherent states. This can be the case when squeezed state are injected into a cavity or a nonlinear element is present in a system. In such cases, during the measurement process, by taking a portion of the optical pulses out of the optical cavity, a kick-back noise may be introduced to the portion of the optical pulses that remains within a cavity. The greater the portion of the optical pulse that is taken out, the greater is the noise introduced.

In some cases, the one or more optical cavities may be used as an optical memory. The optical memory may be made of optical cavities of appropriate lengths that are able to store the optical pulses for a duration that is proportional to the length of the optical cavities. The optical cavities may also possess a phase-sensitive amplifier (PSA) to coherently amplify the stored optical pulses of the cavity to compensate for the optical loss while the pulses remain within the cavity.

In some cases, the stochastic differential equation (SDE) driven by a Levy process is of the form

dx(t)ᵢ=f(x(t)ᵢ,t)dt+g(x(t)ᵢ,t)dZ(t)ᵢ

wherein Z(t) is a Levy process. The Levy process may be the Wiener process, the Poisson process, the gamma process, the Pascal process, the Cauchy process, or the Meixner process. The Levy process may be any stochastic process which satisfies the mathematical definition of a Levy process.

In some cases, the stochastic differential equation is of the form

dxᵢ=f(xᵢ,t)dt+g(xᵢ,t)dWᵢ,

wherein dW is the derivative of the Wiener random process. This type of the stochastic differential equation may also be referred to as a forward stochastic differential equation. The first term, called the drift coefficient, effectively provides a drift force to the evolution of the stochastic processes x(t). The diffusion coefficient, g(x, t), provides randomness. The choice of a drift coefficient and a diffusion coefficient collectively is referred to as a stochastic differential equation in this embodiment.

In some cases, the stochastic differential equation represents Langevin dynamics comprising the gradient descent and a noise term, written as

dcᵢ=−∂ᵢf(c)dt+σdWᵢ, ∀i∈{1, . . . , N}.

While the first term represents the gradient of the objective function and drives the variables towards the minimum of the objective function, the second term makes the process stochastic to increase the chance of finding the global minimum. Here, c is a vector of variables, σ is a constant, dW is the derivative of the Wiener random process, N is the number of variables, and ∂ indicates a partial derivative with respect to a member of c.

In some cases, a controllable noise of the quantum optical modes may be generated using quantum measurements of the quantum optical modes. The measurement system comprising the measurement module 30 may introduce a controllable noise to the pulses within the cavity by discarding the out-coupled optical pulses (e.g., for the noising process), or it may measure the out-coupled amplitudes using a homodyne detection device 42, 44, . . . , 46. The measurement module 30 may perform quantum measurement on the quantum optical modes by taking a portion of the optical pulses out of the optical cavity using the at least one coupler 48, 50, . . . , 52, and performing homodyne detection on them (using, e.g., a homodyne detection device 42, 44, . . . , 46). Assuming that the pulses within the cavity are not coherent states, this measurement process introduces a back-action noise on the pulses that remain within the cavity. The controllable noise is representative of at least a portion of the randomness (i.e., stochasticity) of a stochastic differential equation. The pulses measured by the homodyne measurement system (such as a homodyne detection device 42, 44, . . . , 46) provide the values

$${\tilde{μ}}_{i} = {μ}_{i} + \frac{1}{\sqrt{4 j}} \frac{{dW}_{i}}{dt} ,$$

which provide a noise associated with each pulse. Here, \tilde{μ}ᵢ are the measured pulse amplitudes, μᵢ are the amplitude of the pulses within the cavity, j is the measurement strength, and dWᵢ/dt is the randomness associated with each pulse. If these measured amplitudes \tilde{μ}ᵢ or any function of them are injected back into the input of the at least one coupler 48, 50, . . . , 52, then randomness present in the values of \tilde{μ}ᵢ introduces randomness (i.e., stochasticity) into the stochastic differential equations of the system. In the case wherein the states within the opto-electronic system are coherent states, the SDEs may be written as

$$\frac{d {μ}_{i}}{dt} = - ( 1 + j ) {μ}_{i} + f ( {\tilde{μ}}_{i} ) ,$$

where the stochasticity is introduced through the second term since the argument of the function ƒ is \tilde{μ}ᵢ, which are random variables as shown in the equation disclosed herein.

In some cases, the quantum optical modes are in squeezed states. The amount of squeezing of a squeezed state may control the controllable noise (i.e., stochasticity) of the quantum optical mode. By continuously injecting controllable squeezed states into the opto-electronic system, the randomness in the stochastic differential equation may be controlled. The greater the amount of squeezing is, the greater is the variance of the randomness added to the pulses. A squeezed state may be injected using the at least one coupler 48, 50, . . . , 52. Squeezed states may be generated externally using an optical squeezer and fed into the at least one coupler 48, 50, . . . , 52 using an input port 36, 38, . . . , 40. This injection may happen continuously during each round trip of the pulses around the optical cavity, or once every few iterations.

In some cases, the measurement module 30 models the environment. The quantum measurement may be performed weakly by the environment in the low-photon regime, in which case the at least one coupler 48, 50, . . . , 52 represents the photon loss into a reservoir.

The SDEs described elsewhere herein representing the underlying process of the optical devices and systems disclosed herein assume the system is at zero temperature. While physically this may not be feasible, it represents an accurate approximation of the conditions of the actual system, such as the opto-electronic system described herein with respect to FIG. 3A, FIG. 3B, FIG. 3C, and FIG. 1. At a nonzero temperature, the underlying process may include a noise arising from the effect of quantum measurement performed by the environment on the system, which is reflected in the corresponding SDEs.

In some cases, the measurement module 30 comprises a digital processing unit where the measurement results are converted into one or more digital signals and processed. The digital processing unit may comprise a field-programmable gate array (FPGA).

In some cases, the measurement module 30 comprises an analog electronic processing unit where the measurement results are converted into one or more analog electronic signals and processed. The analog electronic processing unit may comprise a resistive random-access memory (RRAM) device.

The opto-electronic system comprises a processing network 34 operatively connected to the at least one coupler 48, 50, . . . , 52. The processing network 34 may generate at least one programmable optical mode. In some cases, the at least one generated programmable optical mode is at least in part representative of a drift term of the stochastic differential equation. In some cases, the at least one generated programmable optical mode may be in a coherent state with its amplitude modulated by a value representative of the drift term. The coherent state may be generated using an intensity modulator (IM) wherein the optical field from a local oscillator is modulated with a value that is determined by the processing network 34. In some cases, the at least one generated programmable optical mode may be in a squeezed state with its amplitude modulated by a value representative of the drift term. The programmable squeezed state may be generated by coupling a modulated coherent state with a squeezed vacuum state using a beam splitter or a coupler. The squeezed vacuum state may be generated externally using an optical squeezer. In some cases, the at least one generated programmable optical mode may be quantum, meaning that there is quantum entanglement between the optical modes representing the variables and one or more parameters of the model. The at least one generated programmable optical mode may include terms that represent a nonlinear function of the measured optical mode amplitudes \tilde{μ}ᵢ which are random variables. In this case, such terms represent a nonlinear form of randomness (i.e., stochasticity) in the stochastic differential equations. They may be represented as g(xᵢ, dWᵢ, t) in the stochastic differential equation disclosed with respect to FIG. 3A, namely, the coefficient g being dependent on the Wiener process dWᵢ.

In some cases, the processing network 34 may be operatively connected to the measurement module 30 using the connections 60. These connections may be optical waveguides wherein the output of the measurement processing unit 32 is converted to one or more optical signals. The connections 60 may be analog electronic using electronic waveguides or electrical connections. The connections 60 may be digital electronic using electrical connections or electronic waveguides. The at least one generated programmable optical mode may be at least in part representative of at least a portion of the randomness (i.e., stochasticity) of the stochastic differential equation. The at least one generated programmable optical mode may represent terms that are a function of \tilde{μ}ᵢ, which include noise as shown in the equation disclosed herein with respect to FIG. 3A. Therefore, when this at least one generated programmable optical mode is injected back into the one or more optical cavities, it may describe at least in part the randomness (i.e., stochasticity) of the stochastic differential equation. This injection back into the one or more optical cavities may be performed though the at least one coupler 54, 56, . . . , 58. The at least one generated programmable optical mode may represent a drift term that is an identity function, meaning that the optical mode injected back into the one or more optical cavities does not alter the optical modes that are within the one or more optical cavities. In some cases, the at least one generated programmable optical mode may be generated using results of the homodyne measurement of the quantum optical modes. The values of the optical modes measured using the homodyne measurement are represented by \tilde{μ}ᵢ. The at least one generated programmable optical mode may be any function of the measured amplitudes \tilde{μ}ᵢ. It may be a linear function of the measured amplitudes. It may be a quadratic function of the measured amplitudes. It may be a higher-order nonlinear function of the measured amplitudes. The at least one generated programmable optical mode may be fed back to the system. In some cases, the at least one generated programmable optical mode may be fed back using the at least one coupler 54, 56, . . . , 58, where the at least one generated programmable optical mode is fed into one of the input ports of the at least one coupler 54, 56, . . . , 58, while the other input ports of the at least one coupler 54, 56, . . . , 58 are connected to the one or more optical cavities. One of the output ports of the at least one coupler 54, 56, . . . , 58 is connected to the one or more optical cavities. The at least one coupler 54, 56, . . . , 58 may be variable, where the amount of the at least one generated programmable optical mode that is fed back into the optical cavity may be dynamically controlled.

The processing network 34 may comprise any combination of digital electronic components, analog electronic components, optoelectronic components, and optical components. The optical modes may be converted to digital signals using optical analog-to-digital converters (ADC) and back from digital signals to optical modes using optical digital-to-analog converters (DAC). The analog electronic signals may be converted to digital signals using electronic ADCs and back from digital signals to analog electronic signals using electronic DACs. These converters may be realized on-chip together with the FPGA or used externally using separate DAC or ADC devices. The analog optical modes may be converted to analog electronic signals and back using opto-electronic components incorporating opto-electronic materials, such as lithium niobate, wherein an electronic signal may alter the optical properties of the opto-electronic material.

The analog electronic component may comprise a resistive random-access memory (RRAM) device. The digital electronic component may comprise a field-programmable gate array (FPGA). In some cases, the processing network 34 comprises one or more analog electronic components, wherein one or more of those analog electronic components is used to amplify or reshape the signal to compensate for the losses occurring in the system.

In some cases, the processing network 34 comprises nonlinear optical or electronic elements. These nonlinear elements may be capable of implementing a mathematical function that is a nonlinear function of the input optical or electronic signals. The nonlinearity of these components may be of second-order quadratic form. The nonlinearity of these components may be of any other nonlinear form. In some cases, the optical nonlinearity is generated using nonlinear optical materials (e.g., lithium niobate) with strong second-order or third-order optical nonlinearity. In some cases, the optical nonlinearity is generated using photodetectors. The photodetectors may generate an electronic signal that is proportional to the intensity the optical mode receives, which in turn is proportional to the square of the amplitude of the optical field. An electronic signal that is a quadratic function of the optical mode's amplitude may be generated in such a way. The electronic signal may then be processed using analog electronic components, converted to a digital electronic signal, or converted to an optical mode using an optical intensity modulator. The optical nonlinearity may also be generated using other methods. In some cases, the nonlinearity is generated using analog electronic circuits composed of at least one of analog multipliers, amplifiers, potentiometers, or function generators. The electronic components forming such analog electronic circuits may comprise diodes, transistors, differential amplifiers such as operational amplifiers, and passive components such as resistors, inductors, and capacitors. The mathematical operations performed by such analog electronic circuits to compute a nonlinear function of the input signal may comprise addition, integration, inversion, multiplication, exponentiation, logarithmic computation, and division. A nonlinear function may also be generated by a crossbar array of memristive devices (or other RRAM devices) implementing a matrix-vector multiplication between a vector of input signals and an appropriately valued matrix mapped to the conductance states of the memristive devices (or other RRAM devices). Such conductance states of the memristive devices may be programmed with electronic signals. Nonlinear outputs may be computed with analog components such as differential amplifiers. An analog electronic signal may be converted to optical modes and back using opto-electronic components. By using opto-electronic materials, these components are capable of modulating the optical modes with an electronic signal. They are also capable of generating an analog electronic signal using an input optical mode using the same process.

In some cases, the processing network 34 comprises an MZI mesh comprising a network of MZIs. An MZI mesh is a network of MZIs where a matrix-vector multiplication operation is performed by creating couplings between the input optical modes using a network of connected MZIs. The MZI mesh may have any configuration, including a triangular or a rectangular configuration. Such an MZI mesh is reconfigurable by adjusting the two phase shifters in each MZI within the MZI mesh. The parameters of the MZI mesh may continually or continuously be tuned with time. The triangular configuration of the MZI mesh may be implemented similarly to the approach presented in the paper “Experimental realization of any discrete unitary operator.”, Reck et al. Physical review letters 73.1 (1994): 58, which is incorporated herein by reference for all purposes, whereas the rectangular configuration may be implemented similarly to the approach presented in the paper “Optimal design for universal multiport interferometers.”, Clements et al. Optica 3.12 (2016): 1460-1465, which is incorporated herein by reference for all purposes.

In some cases, the processing network 34 comprises a free-space analog optical matrix-vector multiplication (MVM) unit. Such an MVM unit may be created from an array of intensity and phase modulators, where the amplitude and phase of a free-space optical pulse is manipulated using the modulators. The modulators may be electro-optical components where, by applying and changing an electrical signal, the intensity and phase of the optical pulse that is passing through may be changed. Each of N rows of optical pulses representing a variable of the underlying problem may be divided into N columns of optical pulses with identical amplitudes and phases to create an array of N×N optical pulses. These pulses may then be fed into an N×N array of modulators. The output of the modulators may then be collected into N columns by adding optical pulses on the rows of each column of the N×N optical outputs to generate the output of the MVM as a vector of N optical pulses. The result may then be fed back into the rest of the opto-electronic system through couplers. The parameters of the modulators may be determined by the elements of the matrix used for the MVM operation.

In some cases, the processing network 34 is used to generate squeezed states of the quantum optical modes. The amount of squeezing of a squeezed state may control the controllable noise of a quantum optical mode. The squeezed state generated using the processing network 34 may have its mean field amplitude modulated by a value representative of the drift term. In some cases, the squeezed state generated using the processing network 34 may determine the controllable noise by the amount of squeezing of the optical mode. The programmable squeezed state may be generated by coupling a modulated coherent state with a squeezed vacuum state using a beam splitter or a coupler. The squeezed vacuum state may be generated externally using an optical squeezer. The coupled squeezed vacuum state and the modulated coherent state may then be fed into one or more optical cavities using the at least one coupler 54, 56, . . . , 58.

In some cases, the processing network 34 is used to implement an arbitrary function. If the function is a linear function of the input variables, linear operations may be used to implement the function. If the function is nonlinear, a combination of the linear operations and the nonlinear operations disclosed herein with respect to the processing network 34 may be used to implement the nonlinear function exactly or approximately. The implemented arbitrary function may the gradient of an objective function representing an optimization problem. The implemented arbitrary function may be any function of the gradient of the objective function. The arbitrary function may be a function of the variables from previous steps of the Euler method.

In some cases, the processing network 34 includes at least one optical cavity to store the optical pulses and use them to compute the implemented arbitrary function. The optical cavity may store the optical pulses for as many round trips of the Euler method as needed before using them for the next step of the Euler method.

In some cases, the drift term of the stochastic differential equation comprises the drift term of a reverse stochastic differential equation representative of a reverse diffusion. In some cases, the drift term is representative of an optimization problem. In such cases, the drift term may be representative of an objective function. In some cases, the drift term is representative of the gradient of an objective function. In some cases, the drift term is representative of a function of the gradient of an objective function. In some cases, the drift term is representative of a time-dependent function of the gradient of an objective function that depends on previous times. The drift term may depend on other quantities or outputs from other processes.

In some cases, the optimization problem is the box-constrained quadratic programming problem. In some cases, the natural properties of the optical device are used to implement the box constraint of the problem. In some cases, the processing network 34 is used to implement the box constraint.

In some cases, the optimization problem is the maximum-weighted independent set (MWIS) problem, implemented using continuous-variable representation. In some cases, the natural properties of the optical device are used to implement the constraint of the MWIS problem. In some cases, the processing network 34 is used to implement the constraints of the MWIS problem.

In some cases, the optimization problem is the quadratic assignment problem (QAP). In some cases, the natural properties of the optical device are used to implement the constraint of the QAP. In some cases, the processing network 34 is used to implement the constraint of the QAP.

In some cases, the processing network 34 comprises a function approximator comprising one or more parameters and receiving one or more variables as inputs. The one or more parameters may be determined analytically and set prior to processing. The one or more parameters may be determined continually and continuously by training a processing network 34. The one or more input variables may be received as input signals. They may be received as digital signals for a function approximator created using a digital processor (e.g., an FPGA). The one or more input variables may be received as electronic signals for a function approximator that is created using optical or analog electronic components. The one or more input variables may be received as optical modes for a function approximator that is created using optical components. The one or more input variables of the function approximator may be received as optical modes. The one or more input variables of the function approximator may be received as electronic signals received from the output of the measurement system. The function approximator may be trained for approximating the score function of a machine learning model. The function approximator may be able to implement the exact mathematical form of the score function or a polynomial approximation thereof. The score function se is the gradient (with respect to the random variable, i.e., the data) of the log-likelihood of the probability density function, that is, s_{θ}(x, t)=∇ₓ log p(x,t). As it is a gradient, it provides a measure of the change in the log-likelihood given an infinitesimal change in the data. As such, having an accurate score function may guide a stochastic process toward maximizing the log-likelihood and thus generating samples of maximum likelihood, which is the goal of generative machine learning.

In some cases, the function approximator is trained for approximating a function representative of the log of the probability distribution of the data of a machine learning model. In such an embodiment, the function approximator is not representative of the score function itself, and an extra step to evaluate the gradient (e.g., via finite differences) may be used to compute the gradient and thus the score function. This embodiment may have the benefit of providing access to the likelihood function directly, which may be in itself desirable for modelling purposes.

In some cases, the function approximator is trained for approximating the gradient of a function representative of the log of the probability distribution of the data of a machine learning model. In such an embodiment, the output of the function approximator may be directly considered to be the score function, with no additional steps needed to evaluate the gradient.

In some cases, the function approximator comprises a neural network. In some cases, the neural network approximates the drift term of the stochastic differential equation and is used to generate such a drift term. The neural network may be of various types. In some cases, the neural network is an optical neural network, implemented using optical components. The optical neural network may comprise any or a combination of optical components such as phase shifters, beam splitters, phase-sensitive amplifiers, squeezers, and other linear and nonlinear optical elements. In some cases, the neural network is an analog opto-electronic system implemented using a combination of linear optical components, such as beam splitters, phase shifters, or optical squeezers, and nonlinear optical components such as a phase-sensitive amplifier or any other nonlinear optical components incorporating nonlinear optical crystals or opto-electronic materials. The parameters of these components may be controlled externally by controlling the electronic signals that control the optical properties of these components. In some cases, the neural network is an analog electronic system implemented using crossbar arrays of resistive memories (or other RRAM devices) in combination with analog electronic components, such as transistors, operational amplifiers, transimpedance amplifiers, analog switched capacitor circuits, analog passive delay lines, and other resistive and capacitive elements. In some cases, the neural network is analog electronic. The analog electronic system implementing the neural network may comprise circuits providing nonlinearities. These nonlinearities may be generated using analog electronic circuits as disclosed elsewhere herein. In some cases, the neural network is implemented using a combination of analog electronic and analog optical components. The analog components may be any combination of the optical and electronic components disclosed elsewhere herein. The optical modes may be converted to electronic signals and back using converters that are implemented using opto-electronic materials.

In some cases, the neural network is digital, implemented using a digital computing device (e.g., a digital computer or a field-programmable gate array (FPGA)). The digital computer may be of various types. The digital computer may be any digital computer disclosed elsewhere herein. The parameters of the neural network may be pre-programmed (e.g., during inference) or may be dynamically controlled using external parameters such as the results of the measurement system (e.g., during training).

In some cases, the neural network is analog electronic. The analog electronic system implementing the neural network may comprise circuits providing nonlinearities. These nonlinearities may be generated using analog electronic circuits as described elsewhere herein.

In some cases, the measured results from the measurement of the opto-electronic system are interpreted as a latent encoding of input data for use in machine learning methods. In such cases, the opto-electronic system may be initialized to the input data. The opto-electronic system may then be evolved according to the stochastic differential equation that describes the dynamics of the optical device. The state of the optical device may then be measured. The measurement is thus a stochastic transformation of the original input data with the transformation process being carried out by the opto-electronic system. This transformed input data may be stored and then used as input to a machine learning method. For example, it may be used for training of the score function approximator in generative machine learning diffusion models.

In some cases, the opto-electronic system may comprise a plurality of processing networks comprising function approximators. The processing networks may be coupled using one or more optical cavities. The processing networks may be coupled to the same one or more optical cavities using at least one coupler, like the at least one coupler 48, 50, . . . , 52. The function approximators may use measurements of the same optical modes within the same one or more optical cavities by performing homodyne measurements on the optical modes that remain within the same one or more optical cavities. The one or more outputs of the function approximators may be connected to the same one or more optical cavities using at least one coupler, like the at least one coupler 54, 56, . . . , 58. All processing networks coupled to the one or more optical cavities may alter the optical modes that are within the one or more optical cavities.

Now referring to FIG. 3C, there is shown a diagram of an opto-electronic system for simulating at least one solution of a stochastic differential equation (SDE) driven by a Levy process wherein the stochasticity of the Levy process is represented by photon statistics of at least one optical mode, the opto-electronic system having two processing networks and two measurement modules having different functionalities in the machine learning model.

The first measurement module 3010 and processing network 3014 may be used for the training of a generative diffusion model. During training, the parameters of a processing network may be learned for implementing the function approximator of a generative diffusion model. The second measurement module 3016 and the processing network 3020 may be used for the generative part of the machine learning model. Using the parameters obtained from the first processing network 3014, the second processing network 3020 is prepared to generate samples that have a similar distribution to the training data.

In some cases, the feedback generated from the first processing network 3014 is not injected back into one or more optical cavities comprising one or more optical waveguides 3070, meaning that the at least one coupler 3052, 3054, . . . , 3056 may be removed. In such cases, the processing network 3014 may be trained without the need to update the optical pulses within the one or more optical cavities.

In some cases, at least one of the measurement modules 3010 and 3016 may not perform homodyne measurement. In such cases, a homodyne detection device 3034, 3036, . . . , 3038, or 3040, 3042, . . . , 3044 may be bypassed and the optical pulses may go directly into the processing networks 3014 or 3020 through the connections 3072 or 3074, in which case they may be representative of optical waveguides.

In some cases, the optical pulses within the one or more optical cavities are not measured by the second measurement module 3016. In such cases, the second measurement module 3016 and the at least one coupler 3058, 3060, . . . , 3062 may be removed and the second processing network 3020 may generate the samples and feed them into the one or more optical cavities using the at least one coupler 3064, 3066, . . . , 3068.

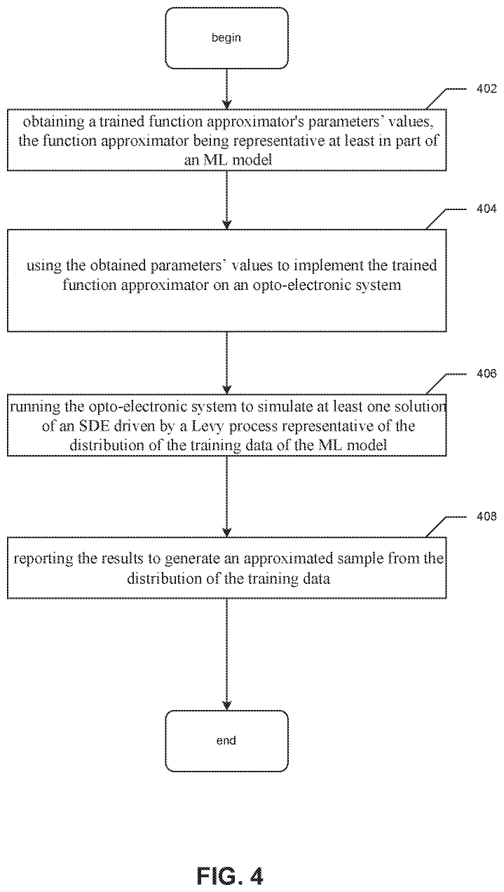

Now referring to FIG. 4, there is shown a flowchart of a method for generating an approximated sample from the distribution of training data.

According to processing operation 402, the values of the parameters of a trained function approximator are obtained. The function approximator is representative at least in part of a machine learning model. The values of the parameters may be obtained by training. Training may be performed classically and non-optically or using an opto-electronic system. In one or more embodiments, training is performed by simulating an optical device. In some cases, training may include performing machine learning techniques such as backpropagation and gradient descent. Training may be performed optically with additional opto-electronic systems designed and implemented specifically to perform backpropagation and gradient descent optically. The function approximator may be of various types. The function approximator may be any function approximator disclosed elsewhere herein, such as the function approximator disclosed herein with respect to FIG. 3B and FIG. 3C and FIG. 1. In some cases, the trained function approximator approximates the score function of a machine learning diffusion model. The trained function approximator may approximate a function representative of the log of the probability distribution of data of a machine learning model. The trained function approximator may approximate the gradient of a function representative of the log of the probability distribution of data of a machine learning model. In some cases, the function approximator comprises at least one of an artificial neural network, a derivative architecture of an artificial neural network, a convolutional neural network, a transformer neural network, and a graph neural network. In some cases, the function approximator is an optical neural network. The function approximator may be trained using machine learning techniques. See, for example, Ho et al. in “Denoising diffusion probabilistic models”, 2020, ArXiv: 2006.11239, which is incorporated by reference herein for all purposes, which set the standard for diffusion models, using a convolutional U-Net architecture, which includes downsampling layers, residual connections, and upsampling layers to efficiently utilize spatial image data.

A technique such as score matching may be used to train the function approximator, such as presented by Song et al. in “Score-Based Generative Modeling through Stochastic Differential Equations”, 2020, ArXiv: 2011.13456, which is incorporated by reference herein for all purposes.

The score matching technique may be implemented as follows. Let Se (x, t) represent the output of the function approximator, which is also known as the score of the data distribution s_{θ}(x, t)≈∇ₓ log p(x,t). Here, a simple objective function may be used to minimize the Euclidean distance between the function approximator and the true data distribution score, that is, the Fisher divergence, which may be given by

$$J = \frac{1}{2} {E}_{{p}_{data}} [ {s}_{θ} ( x , t ) - {s}_{data} ( x , t ) ] .$$

The true score of the data distribution s_{data}(x, t), however, is unknown. Through some mathematical manipulation, one can arrive at an equivalent equation

$$J = {E}_{{p}_{data}} [ tr ( {∇}_{x} {s}_{θ} ( x , t ) ) + \frac{1}{2} {( {s}_{θ} ( x , t ) )}^{2} ] + const .$$

Using this equation does not require knowledge of the true score of the data distribution. It does, however, include a derivative of the output of the function approximator, which is computationally expensive for high-dimensional data x.

Sliced score matching, presented in “Sliced Score Matching” by Song, et al., 2019. ArXiV:1905.07088, which is incorporated herein by reference for all purposes, overcomes the drawback of computational expensiveness by comparing random projections of the score, which is computationally tractable; however, it is an approximation of the previous objective function. The sliced score matching objective function is given by

$$J = {E}_{{p}_{v}} {E}_{{p}_{data}} [ {v}^{T} {∇}_{x} {s}_{θ} ( x , t ) v + \frac{1}{2} {( {v}^{T} {s}_{θ} ( x , t ) )}^{2} ] + const .$$

Here, v~pᵥ are random projection vectors of the same dimensionality as the data, sampled from a Rademacher distribution (i.e., −1 and 1 with equal probability). In other cases, the projection vectors may be sampled from other distributions, such as a uniform distribution. This objective function is computationally tractable and may be used to learn the score function approximator using backpropagation and gradient descent. This is a supervised-learning technique.

To acquire training data, a stochastic differential equation (also referred to as a forward stochastic differential equation) of the form

dxᵢ=f(xᵢ,t)dt+g(xᵢ,t)dWᵢ

may be used. The first term, called the drift coefficient, effectively provides a drift force to the evolution of the stochastic process x. The diffusion coefficient, g(x, t), provides randomness. One can choose drift and diffusion coefficients that are easy to model mathematically, such as in the stochastic differential equation

$$dx = - \frac{1}{2} β ( t ) x dt + \sqrt{β ( t )} dW$$

as used by Song et al. in “Score-Based Generative Modeling through Stochastic Differential Equations”, 2020, ArXiv:2011.13456, which is incorporated by reference herein for all purposes. Alternatively, one can use drift and diffusion coefficients that describe the evolution of a physical system such as an opto-electronic system.

When training, x is initialized to a sample from the training dataset. The differential equation is then evolved forward until a time t. In some cases, this is performed by evolving an opto-electronic system such as the opto-electronic system described herein with respect to FIG. 3A, FIG. 3B, FIG. 3C, and FIG. 1. The state of the opto-electronic system is recorded, that is, x at the time t and the time t may be recorded. The parameters θ of the score function approximator may be updated according to the objective function (e.g., the Fisher divergence) disclosed elsewhere herein.

Every forward stochastic differential equation has a reverse stochastic differential equation (also referred to as a backward stochastic differential equation) given by

dx=[f(x,t)−g²(t)s(x,t)]dt+g(t)dW.

Once an approximation of the score s_{θ}(x, t)≈s(x, t) has been learned, the reverse stochastic differential equation may be evolved to guide the process toward the training distribution.

Still referring to FIG. 4 and according to processing operation 404, the obtained parameters' values are used to implement the trained function approximator on an opto-electronic system. The opto-electronic system may comprise at least one input port for receiving at least one optical mode, a computation and recurrence component, and an output port for readout. The opto-electronic system may be of various types. The opto-electronic system may be any opto-electronic system disclosed elsewhere herein, such as the opto-electronic system disclosed herein with respect to FIG. 3A, FIG. 3B, FIG. 3C, and FIG. 1.

In some cases, the trained function approximator is implemented on a computation and recurrence component such as the computation and recurrence component 100 disclosed herein with respect to FIG. 1. The trained function approximator may be implemented on a processing network, such as the processing network 34 disclosed herein with respect to FIG. 3B or the processing network 3014 or 3020 disclosed herein with respect to FIG. 3C. The trained function approximator may be implemented on a computation and recurrence component or a processing network by mapping the parameters of the trained function approximator onto the parameters of the computation and recurrence component or the processing network. For an analog electronic or optical computation and recurrence component or processing network, the mapping may be performed by finding the parameters of the computation and recurrence component or the processing network such that the mathematical form of the generated output signal closely resembles the trained function approximator. For a digital computation and recurrence component or processing network, the trained function approximator may be directly implemented by the computation and recurrence component or the processing network since a digital computation and recurrence component or processing network is capable of implementing any arbitrary mathematical function. The nonlinear components (i.e., electronic or optical or optoelectronic) in a computation and recurrence component or processing network may be deployed to implement the trained function approximator more accurately. Since the trained function approximator is generally a nonlinear function, incorporating the nonlinear components of a processing network may be necessary to implement a working function approximator.

Still referring to FIG. 4 and according to processing operation 406, the opto-electronic system is run to simulate at least one solution of a stochastic differential equation (SDE) driven by a Levy process representative of the distribution of the training data of the machine learning (ML) model. The opto-electronic system may comprise at least one input port for receiving at least one optical mode, a computation and recurrence component, and an output port for readout. The opto-electronic system may be of various types. The opto-electronic system may be any opto-electronic system disclosed elsewhere herein, such as the opto-electronic system disclosed herein with respect to FIG. 3A, FIG. 3B, FIG. 3C, and FIG. 1.

The opto-electronic system may be evolved to perform the method for simulating at least one solution of the stochastic differential equation (SDE) driven by a Levy process disclosed herein with respect to FIG. 2.

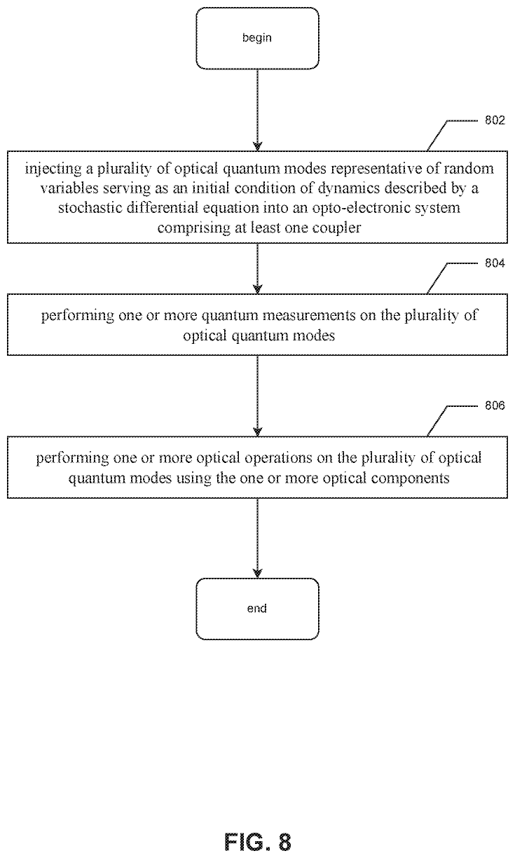

The opto-electronic system may be evolved to perform the method for performing dynamics described by a stochastic differential equation disclosed herein with respect to FIG. 8. The state of the system is initialized to random noise, and the reverse stochastic differential equation is used to evolve the system. At each iteration, the function approximator provides the drift correction in order to guide the evolution of the system toward the predetermined training data distribution.

The machine learning model may be a machine learning diffusion model. The stochastic differential equation representative of the distribution of the training data of the machine learning model may be of various types.

In one or more embodiments, the stochastic differential equation is given by a reverse stochastic differential equation, such as the stochastic differential equation disclosed herein with respect to processing step 402.

The distribution of the training data of the machine learning diffusion model may be of various types. In one or more embodiments, the training data's distribution may be a dataset of images. In some examples, the training data's distribution may be a dataset of handwritten digits, a dataset of images of celebrities, or a dataset of recordings of music.

A machine learning diffusion model may describe several components that work together to provide a generative machine learning framework. One of the components is a stochastic process that incrementally adds noise to a distribution of training data. In some cases, the stochastic process is represented by a forward stochastic differential equation disclosed elsewhere herein. The stochastic differential equation may be implemented using a computational model. Alternatively, the stochastic differential equation may be implemented on an opto-electronic system by using its physical internal functioning. The opto-electronic system may be of various types. The opto-electronic system may be any optical device or system disclosed elsewhere herein, such as the opto-electronic system disclosed herein with respect to FIG. 3A, FIG. 3B, FIG. 3C, and FIG. 1.

A second component of the machine learning diffusion model is a function approximator. The function approximator may be of various types. The function approximator may be any function approximator disclosed elsewhere herein, such as the function approximator disclosed in processing operation 402 and with respect to FIG. 3B, FIG. 3C, and FIG. 1. In some cases, the function approximator comprises at least of an artificial neural network, a derivative architecture of an artificial neural network, a convolutional neural network, a transformer neural network, and a graph neural network. In some cases, the function approximator is an optical neural network. In some cases, the function approximator is an analog electronic neural network. The function approximator may be trained using machine learning techniques. The convolutional neural network may include any number of several types of computational layers, including but not limited to convolutional layers, upsampling layers, downsampling layers, activation layers, copy layers, residual layers, and fully connected layers. The specific choice of combination and hyperparameters of these layers may be a neural network architecture.

A third component of the machine learning diffusion model is a reverse stochastic process. Every forward stochastic differential equation of the form disclosed above has a reverse stochastic differential equation (also referred to as a backward stochastic differential equation) given by

dx=[f(x,t)−g²(t)s(x,t)]dt+g(t)dW.

Once an approximation to the score s_{θ}(x, t)≈s(x, t) is learned, the reverse stochastic differential equation may be evolved to guide the process toward the training distribution. The reverse stochastic differential equation may be implemented using the function approximator. More precisely, the s(x, t) term is provided from the function approximator disclosed elsewhere herein.

Still referring to FIG. 4 and according to processing operation 408, results are reported to generate an approximated sample from the distribution of the training data. A readout is performed at the end of the evolution of the system, which represents an approximated sample from the distribution of the training data. In some cases, homodyne measurements are performed at the end of the evolution of the system by measuring the amplitudes of the quantum optical modes which represent an approximated sample from the distribution of the training data.

In some cases, prior to processing operation 402, the function approximator is trained to obtain its parameters' values.

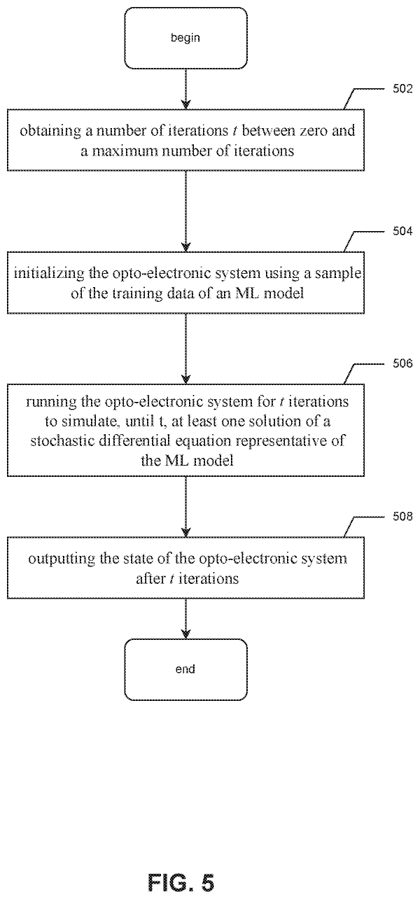

Now referring to FIG. 5, there is shown a flowchart of a method for training a function approximator.

According to processing operation 502, a number of iterations t between zero and a maximum number of iterations T is obtained. The maximum number of iterations T may be determined empirically. The maximum number of iterations T may be large enough so that all information in the data sample is destroyed through the forward stochastic process, and the terminal state of the system x(T) is a sample from an easily sampled prior distribution. In some cases, the prior distribution is Gaussian. The number of iterations t may be sampled uniformly between 0 and T, or it may be sampled using a sampling method, such as importance sampling, in an effort to improve performance. When importance sampling is used, the sampling distribution from which t is drawn is weighted by a function proportional to the error in score prediction.

Still referring to FIG. 5 and according to processing operation 504, the opto-electronic system is initialized using a sample of the training data of a machine learning model. More precisely, in some cases, the initial state of the system x(0) is set to a sample from the training dataset, that is, it is sampled from the training distribution. The signals representative of the sample from the training data may be analog optical or electronic signals. In the case of analog optical signals, optical pulses may represent the initial state of the system. The initial optical pulses may comprise vacuum states, squeezed states, coherent states, or other optical quantum states. In the case of analog electronic signals, variables representing the initial state may be encoded as voltage or current signals of given amplitudes, durations, phases, or shapes. The optical or electronic signals representative of the initial state of the system may be generated within the computation and recurrence component, such as the computation and recurrence component 100 represented herein with respect to FIG. 1, or may be generated externally and fed into the system through input ports, as described elsewhere herein. The opto-electronic system may be of various types. The opto-electronic system may be any opto-electronic system disclosed elsewhere herein, such as the opto-electronic system disclosed herein with respect to FIG. 3A, FIG. 3B, FIG. 3C, and FIG. 1.

In some cases, a plurality of optical modes having photon statistics representative at least in part of the stochasticity of the Levy process which Levy process drives the stochastic differential equation (SDE). The optical modes may be of various types. In some cases, the optical modes are quantum optical modes. In some cases, the optical modes comprise squeezed states. In some cases, the optical modes comprise vacuum states. In some cases, the optical modes comprise coherent states. The optical modes may comprise vacuum states converted into squeezed states. Vacuum states may be injected by leaving the at least one input port, as described elsewhere herein, open. By leaving the at least one input port open, the vacuum states of light may be injected into the system. A squeezed vacuum state may be generated externally using a squeezing device that receives strong coherent light (e.g., from a laser source) and generates a squeezed vacuum state. Then, the output of the squeezing device may be fed into the at least one input port of the opto-electronic system. Squeezed vacuum states may have greater uncertainty in one of the quadratures of the optical field (e.g., the real part of the optical field) and less uncertainty in the conjugate quadrature. This is a purely quantum effect where the uncertainty may be below the minimum uncertainty in one of the quadratures. Compared to a vacuum state, a squeezed vacuum state may have a greater amount of quantum noise which may be used to control the stochasticity of the Levy process more freely compared to the vacuum state injection. Coherent states of light may also be injected into at least one input port of the opto-electronic system. Coherent states are classical states of light with a minimum quantum noise limit, where the photon statistics in the optical modes may be used to generate stochasticity. Coherent states may be generated using an external laser source and fed into at least one input port of the opto-electronic system. The amount of squeezing of the squeezed state may control the stochasticity (i.e., noise) of a quantum optical mode. By continuously injecting controllable squeezed states into the opto-electronic system, the randomness in the stochastic differential equation (SDE) may be controlled. The greater the amount of squeezing is, the greater is the variance of the randomness added to the pulses. This injection may happen continuously during each round trip of the pulses in the opto-electronic system, or once every few iterations. In some cases, the plurality of optical modes is programmable. The optical modes may be quantum meaning that there is quantum entanglement between the optical modes.

In some cases, a plurality of quantum optical modes may be injected as squeezed vacuum states using squeezers, or as coherent states using external laser sources. These laser sources operate at the same wavelength as the rest of the opto-electronic system. A single laser source may be used to generate pulses of different amplitudes by dynamically controlling the power of the laser or by continuously using an intensity and a phase modulator to create the required initial amplitudes and phases of the optical pulses. The chain of pulses generated by the laser can then be synchronized using a network of delay lines, so all the pulses on different optical lines arrive at the opto-electronic system, such as the ones disclosed with respect to FIG. 3A, FIG. 3B, FIG. 3C, and FIG. 1. These optical lines may be connected to the opto-electronic system using optical cavities similar to the optical cavities disclosed with respect to FIG. 3A, FIG. 3B, FIG. 3C, and FIG. 1. The optical pulses generated by the laser are all in the same optical mode but with different parameters. Each optical pulse is an independent optical mode from the rest of the optical pulses, but all have the features of the same optical mode that is created using the same laser source or the same squeezer.

Still referring to FIG. 5 and according to processing operation 506, the opto-electronic system is run for t iterations to simulate, until t, at least one solution of a stochastic differential equation representative of the machine learning (ML) model. The forward stochastic differential equation may be used to evolve the system.

In some cases, the opto-electronic system is evolved to perform the method for simulating at least one solution of the stochastic differential equation (SDE) driven by a Levy process disclosed herein with respect to FIG. 2.

In some cases, the opto-electronic system is evolved to perform the method for performing dynamics described by a stochastic differential equation disclosed herein with respect to FIG. 8.

In some cases, the amplitudes and phases of the optical pulses are transformed to values representative of a prior distribution, such as, for example, random Gaussian noise with a mean of zero. The values representing the snapshot of the system used for training, that is, x(t), may be obtained using homodyne measurements by measuring the amplitudes of the quantum optical modes at the iteration t. The values representing the snapshot of the system used for training, that is, x(t), may be obtained by performing a readout as described herein with respect to FIG. 2 and FIG. 1.

In some cases, the stochastic differential equation is given by

dx=f(x,t)dt+g(t)dW,

where the first term, known as the drift coefficient, effectively provides a drift force to the evolution of the stochastic process x(t). The diffusion coefficient, g(t), provides randomness. One can choose drift and diffusion coefficients that are easy to model mathematically, as done in Song, et al. “Score-Based Generative Modeling through Stochastic Differential Equations”. 2020. ArXiv: 2011.13456, which is incorporated herein by reference for all purposes. In another embodiment, drift and diffusion coefficients that describe the evolution of a physical system, such as an opto-electronic system may be used.

The forward stochastic differential equation is used to generate one or more training signals for the function approximator.

The distribution of the training data of the machine learning diffusion model may be of various types. In some cases, the training data's distribution may be a dataset of images. In some cases, the training data's distribution may be a dataset of handwritten digits, a dataset of images of celebrities, or a dataset of recordings of music.

A machine learning diffusion model may describe several components that work together to provide a generative machine learning framework. One of the components is a stochastic process that incrementally adds noise to a distribution of training data. In some cases, the stochastic process may be represented by a forward stochastic differential equation disclosed elsewhere herein. The stochastic differential equation may be implemented using a computational model. Alternatively, the stochastic differential equation may be implemented on an opto-electronic system by using its physical internal functioning. The opto-electronic system may be of various types. The opto-electronic system may be any optical device or system disclosed elsewhere herein, such as the opto-electronic system disclosed herein with respect to FIG. 3A, FIG. 3B, FIG. 3C, and FIG. 1.

A second component of the machine learning diffusion model is a function approximator. The function approximator may be of various types. The function approximator may be any function approximator disclosed elsewhere herein, such as the function approximator disclosed herein in processing operation 402 of FIG. 4 and with respect to FIG. 3B, FIG. 3C, and FIG. 1. In some cases, the function approximator comprises at least one of an artificial neural network, a derivative architecture of an artificial neural network, a convolutional neural network, a transformer neural network, and a graph neural network. In some cases, the function approximator is an optical neural network. In some cases, the function approximator is an analog electronic neural network. The function approximator may be trained using machine learning techniques. The convolutional neural network may include any number of several types of computational layers, including but not limited to convolutional layers, upsampling layers, downsampling layers, activation layers, copy layers, residual layers, and fully connected layers. The specific choice of combination and hyperparameters of these layers may comprise a neural network architecture.

A third component of the machine learning diffusion model is a reverse stochastic process. Every forward stochastic differential equation of the general form disclosed herein has a reverse stochastic differential equation (also referred to as a backward stochastic differential equation) given by

dx=[f(x,t)−g²(t)s(x,t)]dt+g(t)dW.

Once an approximation to the score s_{θ}(x, t)≈s(x, t) is learned, the reverse stochastic differential equation may be evolved to guide the process toward the training distribution. The reverse stochastic differential equation may be executed using the function approximator. More precisely, the s(x, t) term is provided from the function approximator disclosed elsewhere herein.

Still referring to FIG. 5 and according to processing operation 508, the state of the system after t iterations (x(t), t) is output, and the parameters θ of the score function approximator are updated according to the objective function. This may be carried out using backpropagation to compute the partial derivatives of the objective function with respect to each parameter θ of the function approximator. A small optimization step using gradient descent may then be performed to modify θ in the direction that minimizes the objective function. Gradient descent may include any update rule, such as stochastic gradient descent, or Adam as presented by Kingma & Ba in “Adam: A Method for Stochastic Optimization”. 2014. arXiv: 1412.6980, which is incorporated herein by reference for all purposes.

The state of the system may be observed by performing homodyne measurements on the quantum optical modes of the opto-electronic system. By comparing the optical pulses against a reference source such as an external laser generating the optical pulses, these measurements may provide the values for the amplitudes and phases of the optical pulses. These values may then be interpreted as the training samples used to train the function approximator by taking their values to represent the random processes that are used as data points in the training process. The state of the system may be observed by performing a readout as described herein with respect to FIG. 2.

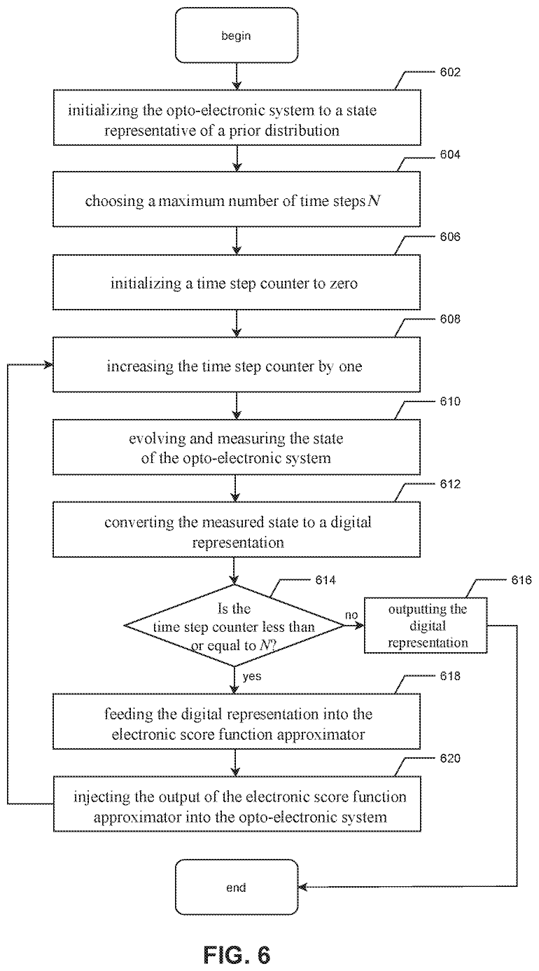

Now referring to FIG. 6, there is shown a flowchart of a method for generating a sample from the distribution of the training data of a generative machine learning model using a hybrid opto-electronic system having an optical device coupled with an electronic score function approximator. The hybrid opto-electronic system may be of various types. The hybrid opto-electronic system may be any hybrid opto-electronic system disclosed elsewhere herein, such as the hybrid opto-electronic system disclosed herein with respect to FIG. 3A, FIG. 3B, FIG. 3C, and FIG. 1. The optical device may be of various types. The optical device may be any optical device disclosed elsewhere herein, such as the optical device disclosed herein with respect to FIG. 3A, FIG. 3B, FIG. 3C, and FIG. 1. The parameters of the electronic score function approximator may be considered fixed and may be determined through a process called training as disclosed elsewhere herein. The electronic score function may be of various types. The electronic score function approximator may be any score function approximator comprising electronic components disclosed elsewhere herein. In some cases, the electronic score function includes the use of a field-programmable gate array (FPGA). The electronic score function approximator may be a digital neural network. In some cases, the electronic score function approximator includes the use of a crossbar array of memristive devices (or other RRAM devices). The electronic score function approximator may comprise an analog neural network.

Every forward stochastic differential equation of the general form disclosed elsewhere herein has a reverse stochastic differential equation (also referred to as a backward stochastic differential equation) given by

dx=[f(x,t)−g²(t)s(x,t)]dt+g(t)dW.

Once an approximation to the score s_{θ}(x, t)≈s(x, t) has been learned, the reverse stochastic differential equation may be evolved to guide the process toward the training distribution. The reverse stochastic differential equation may be implemented using the electronic score function approximator. More precisely, the s(x, t) term is provided from the electronic score function approximator disclosed herein.

Still referring to FIG. 6 and according to processing operation 602, the opto-electronic system is initialized to a state representative of a prior distribution. The prior distribution is determined by the terminal state of the forward stochastic process (described by the forward stochastic differential equation) used to train the electronic score function approximator. The forward stochastic process may be chosen in such a way that the prior distribution is an easily sampled from distribution. In some cases, the prior distribution is Gaussian with a mean of zero. The opto-electronic system may be of various types. The opto-electronic system may be any opto-electronic system disclosed elsewhere herein such as any opto-electronic system disclosed herein with respect to FIG. 3A, FIG. 3B, FIG. 3C, and FIG. 1. The optical device is initialized using the background vacuum noise upon activation of the opto-electronic system which generates Gaussian states with a mean of zero. These vacuum states are present in the optical waveguides of the opto-electronic system.

According to processing operation 604, a maximum number of time steps N is chosen. This value is chosen to be equal to the number of time steps used in training the electronic score function approximator.

According to processing operation 606, a time step counter is initialized to zero.

According to processing operation 608, the time step counter is increased by one.

According to processing operation 610, the opto-electronic system is evolved, and its state is measured. To evolve the opto-electronic system, a chain of optical pulses, representing random variables serving as an initial condition of dynamics described by the stochastic differential equation, may be generated. These pulses may be generated as vacuum states, as squeezed vacuum states using squeezers, or as coherent states using an external laser source. These pulses may then travel through the network of optical components, such as beam splitters, directional couplers, phase shifters, amplifiers, squeezers, and other linear and nonlinear optical components. The amplitudes of the pulses representing the random processes of the stochastic differential equations may be obtained using homodyne measurements at the end of the processes.

According to processing operation 612, the measured state is converted to a digital representation of the form of the training dataset. In some cases, the digital representation is an image. In some cases, the digital representation comprises other structured data. The conversion to a digital representation may be performed using an analog-to-digital converter (ADC). The ADC may be located within a homodyne detection device.

According to decision operation 614, if the time step counter's value is larger than the maximum number of time steps N, then processing operation 616 is performed; if the time step counter's value is less than or equal to the maximum number of time steps N, then processing operation 618 is performed.

According to processing operation 616, the digital representation is output, after which the process terminates. The output digital representation is considered to be a sample from the training distribution, that is, a sample generated by the generative machine learning model.

According to processing operation 618, the digital representation is fed into the electronic score function approximator. The electronic score function approximator may comprise a digital neural network. The digital neural network may include any number of several types of computational layers, including, but not limited to, convolutional layers, upsampling layers, downsampling layers, activation layers, copy layers, residual layers, and fully connected layers. The output of the digital neural network may approximate the score function. The digital neural network may be connected to the opto-electronic system using a multitude of elements, including analog-to-digital converters (ADC), digital-to-analog converters (DAC), intensity modulators (IM), and phase modulators (PM). An ADC converts optical signals to electronic signals that can be processed using a digital processor. A DAC converts the digital signal output of the digital processor to optical signals that are at a suitable operation wavelength for the hybrid opto-electronic system. Intensity modulators may be used to adjust and correct the amplitudes of the optical signals generated using a DAC so that they match the amplitude level of the optical pulses prior to entering the digital processor. Phase modulators may be used to adjust the phase of the optical pulses generated by a DAC so that they are in phase with the rest of the optical pulses within an optical cavity. The IMs and PMs may be connected to a main laser source to receive a clock time, amplification energy, and a reference phase.

According to processing operation 620, the output of the electronic score function approximator is injected into the opto-electronic system. More precisely, the output of the score function approximator is optically encoded into the system as optical pulses. The opto-electronic system continues to evolve, and the process moves to processing operation 608. The injection of the output optical signal from the function approximator into the system may be performed using beam splitters, where the optical signal from the function approximator couples with the signal from within the optical cavity through the inputs of the beam splitter and add up at the output of the beam splitter to create the optical signal that continues to remain within the optical cavity.

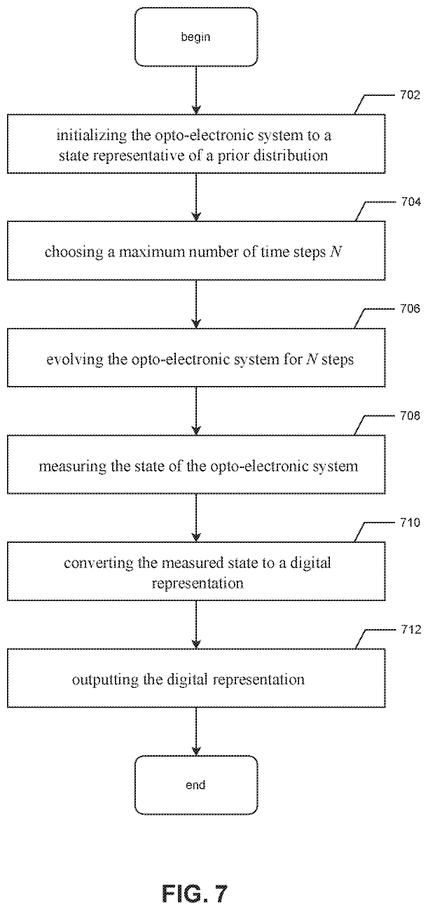

Now referring to FIG. 7, there is shown a flowchart of a method for generating a sample from the distribution of the training data of a generative machine learning model using an opto-electronic system having an optical score function approximator. The opto-electronic system having an optical score function approximator may be of various types. The opto-electronic system having an optical score function approximator may be opto-electronic system having an optical score function approximator disclosed elsewhere herein, such as the opto-electronic system having an optical score function approximator disclosed herein with respect to FIG. 3B, FIG. 3C, and FIG. 1. The optical score function approximator may be of various types. In some cases, the optical score function approximator may comprise a neural network, such as the neural network disclosed herein with respect to FIG. 3B, FIG. 3C, and FIG. 1. The optical score function approximator may represent a parameterized model, with parameter values determined through a process called training as disclosed elsewhere herein. This training process may be carried out electronically, with the determined parameter values then being statically encoded as parameters of the opto-electronic system. The optical score function approximator may also be trained optically through an optical optimization process.

Still referring to FIG. 7 and according to processing operation 702, the opto-electronic system is initialized to a state representative of a prior distribution. The prior distribution is determined by the terminal state of the forward stochastic process (described by the forward stochastic differential equation) used to train the optical score function approximator. The forward stochastic process may be chosen in such a way that the prior distribution is an easily sampled distribution. In some cases, the prior distribution is Gaussian. The opto-electronic system may be of various types. The opto-electronic system may be any opto-electronic system disclosed elsewhere herein such as any opto-electronic system disclosed herein with respect to FIG. 3A, FIG. 3B, FIG. 3C, and FIG. 1. The opto-electronic system is initialized using the background vacuum noise which generates Gaussian states with a mean of zero. These vacuum states are present in the optical waveguides of the opto-electronic system.

According to processing operation 704, a maximum number of time steps N is chosen. This value may be chosen to be equal to the number of time steps used in training the optical score function approximator.

According to processing operation 706, the opto-electronic system designed to be representative of the reverse stochastic process is evolved for N steps. The optical score function approximator may be optically coupled directly with the optical device and they may then operate simultaneously without user interaction. The opto-electronic system designed to be representative of the reverse stochastic process possesses the same diffusion coefficient as the forward process, g(t). It has a modified drift term comprising the drift term of the forward process f(x, t) and the square of the diffusion coefficient coupled with the output of the score function approximator, consistent with the reverse stochastic differential equation:

dx=[f(x,t)−g²(t)s(x,t)]dt+g(t)dW.

According to processing operation 708, the state of the opto-electronic system is measured. The state of the system may be observed by performing homodyne measurements on the optical modes of the opto-electronic system. By comparing the optical pulses against a reference source such as an external laser generating the optical pulses, these measurements may provide the values of the amplitudes and phases of the optical pulses. These values may then be interpreted as the output of the generative machine learning model.

According to processing operation 710, the measured state is converted to a digital representation. This may be done using a digital-to-analog converter (DAC). The DAC may be located within a homodyne detection device.

According to processing operation 712, the digital representation is output, after which the process terminates. The output digital representation is considered a sample from the training distribution, that is, a sample generated by the generative machine learning model.

Now referring to FIG. 8, there is shown a flowchart of a method for performing dynamics described by a stochastic differential equation.

According to processing operation 802, a plurality of quantum optical modes representative of random variables serving as an initial condition of dynamics described by a stochastic differential equation is injected into an opto-electronic system comprising at least one coupler having one or more optical components. The opto-electronic system may be of various types. The opto-electronic system may be any opto-electronic system disclosed elsewhere herein, such as the opto-electronic systems disclosed with respect to FIG. 3A, FIG. 3B, FIG. 3C, and FIG. 1.

The plurality of quantum optical modes may be injected as squeezed vacuum states using squeezers, or as coherent states using external laser sources. These laser sources may operate at the same wavelength as the rest of the opto-electronic system. A single laser source may be used to generate pulses of different amplitudes by dynamically controlling the power of the laser or by continuously using an intensity and a phase modulator to create the required initial amplitudes and phases of the optical pulses. The chain of pulses generated by the laser can then be synchronized using a network of delay lines, so all the pulses on different optical lines arrive at an opto-electronic system, such as the ones disclosed with respect to FIG. 3A, FIG. 3B, FIG. 3C, and FIG. 1. These optical lines may be connected to the opto-electronic system using optical cavities similar to the optical cavities disclosed with respect to FIG. 3A, FIG. 3B, FIG. 3C, and FIG. 1. The optical pulses generated by the laser are all in the same optical mode but with different parameters. Each optical pulse is an independent optical mode from the rest of the optical pulses, but all have the features of the same optical mode that is created using the same laser source or the same squeezer.

According to processing operation 804, one or more quantum measurements are performed on the plurality of quantum optical modes. The one or more quantum measurements may be used to control the random noise corresponding to the noise (also called diffusion) coefficient of the stochastic differential equation.

According to processing operation 806, one or more optical operations are performed on the plurality of quantum optical modes using the one or more optical components. The one or more optical operations may be of various types. The one or more optical operations may comprise an analog optical operation, a digital operation, or an analog electronic operation. The digital operation may comprise converting the quantum optical modes to digital signals, performing digital processing on the digital signals, and converting the digital signals back to quantum optical modes. The analog electronic operation may comprise converting quantum optical modes to analog electronic signals, performing analog electronic processing on the analog electronic signals, and converting the analog electronic signals back to quantum optical modes.

The converting of quantum optical modes to digital signals may comprise converting quantum optical modes to analog electronic signals and converting the analog electronic signals to digital signals. The converting of digital signals back to quantum optical modes may comprise converting the digital signals to analog electronic signals and converting the analog electronic signals to quantum optical modes.

One or more digital operations may be performed on the plurality of optical pulses comprising converting one or more optical pulses of the plurality of optical pulses to digital signals, performing digital processing on the one or more optical pulses, and converting the digital signals back to optical pulses. The one or more optical operations and/or the one or more digital operations may be used to generate the drift term of the stochastic differential equation.

Processing operations 804 and 806 may be repeated one or more times to simulate dynamics described by the stochastic differential equation. By repeating processing operations 804 and 806 using multiple instances of the opto-electronic system or by synchronistically looping the one or more optical pulses through the system multiple times using a feedback loop, the amplitudes and phases of the one or more optical pulses may be converged to values representing a sample from the distribution of the stochastic process corresponding to solving the stochastic differential equation. In some cases, the state of the opto-electronic system may be observed by performing homodyne measurements on the quantum optical modes of the opto-electronic system. The values of the amplitudes of the one or more optical pulses at each iteration may be obtained using homodyne measurements continually during the process by measuring the one or more optical pulses at each iteration. The values may be obtained by measuring the amplitudes of the one or more optical pulses at the end of the process. By comparing the optical pulses against a reference source such as an external laser generating the optical pulses, these measurements may provide the values for the amplitudes and phases of the optical pulses. The state of the system may be observed by performing a readout as described herein with respect to FIG. 2.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. An opto-electronic system for simulating at least one solution of a stochastic differential equation (SDE) driven by a Levy process, the system comprising:
at least one input port for receiving at least one optical mode, wherein a stochasticity of said Levy process is represented by photon statistics of said at least one optical mode; and
a computation and recurrence component configured to perform one or more operations on one or more signals derivative of said at least one optical mode to simulate said at least one solution to said stochastic differential equation.

2. The opto-electronic system of claim 1, wherein the computation and recurrence component is further configured to implement at least a portion of a generative machine learning model based on said at least one optical mode.

3. (canceled)

4. The opto-electronic system of claim 1, wherein said computation and recurrence component comprises one or more members selected from the group consisting of: a digital electronic component, an analog electronic component, an opto-electronic component, and an optical component.

5-10. (canceled)

11. The opto-electronic system of claim 1, wherein each variable and one or more parameters of said SDE is represented by at least one of an optical signal or an electronic signal.

12. (canceled)

13. (canceled)

14. The opto-electronic system of claim 1, wherein said computation and recurrence component comprises a feedback loop comprising at least one of an electronic component or an optical component.

15. The opto-electronic system of claim 1, wherein said computation and recurrence component comprises a signal aggregator configured to add signals.

16. The opto-electronic system of claim 15, wherein said signal aggregator comprises a circuit node, a summing amplifier circuit, or one or more optical components comprising at least one coupler.

17. The opto-electronic system of claim 1, wherein said at least one optical mode comprises at least one member of the group consisting of: a squeezed state, a vacuum state, and a coherent state; further wherein said at least one optical mode is injected using said at least one input port.

18. (canceled)

19. The opto-electronic system of claim 1, wherein said stochasticity is controlled using quantum measurements, wherein a quantum measurement from said quantum measurements changes the photon statistics of one or more optical modes of said at least one optical mode; further wherein a quantum measurement of an optical mode of said at least one optical mode creates an optical mode with photon statistics different from that of said measured optical mode.

20-27. (canceled)

28. The opto-electronic system of claim 1, wherein said computation and recurrence component comprises a free-space or on-chip analog optical matrix-vector multiplication (MVM) unit.

29. (canceled)

30. The opto-electronic system of claim 1, wherein said computation and recurrence component comprises a processing network, wherein an output of said processing network is at least in part representative of said stochasticity, which stochasticity is generated using results of said a homodyne measurement of said at least one optical mode.

31-35. (canceled)

36. The opto-electronic system of claim 1, wherein said computation and recurrence component comprises a function approximator comprising one or more parameters and one or more variables as an input.

37-40. (canceled)

41. The opto-electronic system of claim 1, wherein said stochastic differential equation is representative of Langevin dynamics.

42. (canceled)

43. (canceled)

44. The opto-electronic system of claim 1, wherein said stochastic differential equation is representative of an optimization problem.

45. (canceled)

46. A method for simulating at least one solution of a stochastic differential equation (SDE) driven by a Levy process in an opto-electronic system, said method comprising:
(a) generating, at an opto-electronic system, signals representative of an initial condition of the variables and one or more parameters of said stochastic differential equation (SDE);
(b) receiving, at said at least one input port, one or more optical modes having photon statistics representative at least in part of said stochasticity of said Levy process which Levy process drives said stochastic differential equation (SDE); and
(c) performing, at a computation and recurrence component operatively coupled to said input port, one or more operations on said signals representative of said variables and said one or more parameters of said stochastic differential equation (SDE) and one or more signals derivative of said at least one optical mode to simulate said at least one solution to said stochastic differential equation.

47. The method of claim 46, further comprising performing, at said computation and recurrence component, recurrence by repeating (b) and (c) at least one time.

48. The method of claim 46, providing a readout at a readout port of said opto-electronic system.

49-52. (canceled)

53. The method of claim 46, wherein said one or more operations comprise at least one member of the group consisting of: (i) an analog optical operation; (ii) a digital operation; (iii) an analog electronic operation; (iv) converting a digital signal to an optical mode; (v) converting an analog electronic signal to an optical mode; (vi) converting an analog electronic signal to a digital signal; (vii) converting a digital signal to an analog electronic signal; (viii) converting an optical mode to a digital signal; and (ix) converting an optical mode to an analog electronic signal.

54. (canceled)

55. A method for generating an approximated sample from the distribution of the training data, said method comprising:
(a) obtaining values of a plurality of parameters of a trained function approximator, wherein said trained function approximator is representative at least in part of a machine learning (ML) model;
(b) implementing said trained function approximator on an opto-electronic system using at least said values of said plurality of parameters, wherein said opto-electronic system comprises at least one input port configured to receive at least one optical mode, and a computation and recurrence component;
(c) simulating, at said opto-electronic system, at least one solution of a stochastic differential equation (SDE) driven by a Levy process representative of said distribution of said training data of said machine learning (ML) model; and
(d) generating an approximated sample based at least in part on said at least one solution from said distribution of said training data.

56. The method of claim 55, further comprising prior to (a) training said function approximator to obtain said parameters' values.

57-126. (canceled)
